(19) United States
(12) Patent Application Publication
(10) Pub. No.: US 2025/0183023 A1
(43) Pub. Date: Jun. 5, 2025

(54) SYSTEM AND METHOD FOR SIMULTANEOUS ANALYSIS OF MULTIPLE CHARGED PARTICLES WITH A CHARGE DETECTION MASS SPECTROMETER

(71) Applicants: THE TRUSTEES OF INDIANA UNIVERSITY, Bloomington, IN (US); MEGADALTON SOLUTIONS, INC., Bloomington, IN (US)

(72) Inventors: Martin F. JARROLD, Bloomington, IN (US); Raj A. PARIKH, Bloomington, IN (US); Benjamin E. DRAPER, Bloomington, IN (US)

(21) Appl. No.: 18/960,229

(22) Filed: Nov. 26, 2024

Related U.S. Application Data
(60) Provisional application No. 63/605,025, filed on Dec. 1, 2023.
(60) Provisional application No. 63/651,607, filed on May 24, 2024.

(51) Int. Cl. H01J 49/02; H01J 49/00; H01J 49/42

(52) U.S. Cl. CPC H01J 49/025; H01J 49/0036; H01J 49/425

(57) ABSTRACT

A system and method are provided for recovering charged particle measurement information in the operation of a charge detection mass spectrometer in which multiple ions are trapped and simultaneously measured. The recovered charged particle measurement information illustratively includes charged particle measurement information for at least some of the ions having oscillation frequencies that overlap with oscillation frequencies of others of the multiple trapped ions. One example charged particle recovery process operates on charged particle measurement information in which the overlapping oscillation frequencies are discernible from one another, and another operates on charged particle measurement information in which the overlapping oscillation frequencies are indiscernible from one another. The charge detection mass spectrometer may be operated using either or both of the charged particle recovery processes.

### CROSS-REFERENCE TO RELATED APPLICATIONS

This application claims priority under 35 U.S.C. § 119 (e) to U.S. Provisional Application Ser. No. 63/605,025 filed on Dec. 1, 2023 and to U.S. Provisional Application Ser. No. 63/651,607 filed May 24, 2024, the disclosures of which are expressly incorporated herein by reference in their entireties.

### GOVERNMENT RIGHTS

This invention was made with government support under GM131100 awarded by the National Institutes of Health. The United States Government has certain rights in the invention.

### TECHNICAL FIELD

The present disclosure relates generally to charge detection mass spectrometry (CDMS), and more specifically to systems and techniques for simultaneously analyzing multiple charged particles.

### BACKGROUND

Charge detection mass spectrometry (CDMS) is a charged particle analysis technique in which masses of individual charged particles are determined from simultaneous measurements of their mass-to-charge ratios (m/z) and charge magnitudes (z). Charged particles are trapped in an electrostatic linear ion trap or an orbitrap, and measurements are made of charges induced by the charged particles on a charge detector as they oscillate back and forth through or about the charge detector for the duration of the trapping event. Simultaneously trapping multiple charged particles can significantly increase CDMS throughput and thereby reduce analysis time, although this approach can lead to increased rejection of charged particle measurement information from the analysis results, as compared with that of single particle analysis techniques, due to errors in determination of the charge magnitude and/or in determination of the oscillating frequency resulting from charged particles having overlapping oscillation frequencies.

### SUMMARY

The present disclosure may comprise one or more of the features recited in the attached claims, and/or one or more of the following features and combinations thereof. In one aspect, a method of operating a charge detection mass spectrometer, including an electrostatic linear ion trap (ELIT) or an orbitrap, may comprise (i) trapping multiple ions, generated from a sample, in the ELIT or orbitrap such that the multiple trapped ions oscillate back and forth through or about a charge detector of the ELIT or orbitrap during an ion trapping event, (ii) determining a set of oscillation frequency (OFR) and charge magnitude (CM) pairs each corresponding to a different one of the multiple trapped ions, (iii) forming filtered and recovery files from the set of OFR and CM pairs, the filtered file including OFR and CM pairs from which a spectral distribution of the sample is to be produced, and the recovery file including OFR and CM pairs having oscillation frequencies that overlap with oscillation frequencies of other OFR and CM pairs, wherein the overlapping oscillation frequencies in the recovery file are discernible from one another, (iv) for at least one of the OFR and CM pairs in the recovery file, (a) modifying the charge magnitude of the OFR and CM pair as a function of the charge magnitude of one of the OFR and CM pairs in the filtered file having an oscillation frequency in the ELIT or orbitrap that is within a frequency window of an oscillation frequency in the ELIT or orbitrap of the OFR and CM pair, and (b) updating the filtered file by adding the OFR and modified CM pair thereto, and (v) producing the spectral distribution from the updated filtered file of OFR and CM pairs.

A second aspect includes the features of the first aspect, and may further comprise executing (i)-(iv) multiple times, followed by executing (v) using the updated filtered file containing OFR and CM pairs for all of the multiple executions of (i)-(iv).

A third aspect includes the features of the first or the second aspect, and may further comprise collecting charge detection data resulting from detection of charges induced by the multiple ions on the charge detector over the ion trapping event, wherein (ii) comprises analyzing the collected charge data to determine the set of oscillation frequency (OFR) and charge magnitude (CM) pairs, and to determine a charge magnitude standard deviation for each of the OFR and CM pairs.

A fourth aspect includes the features of the third aspect, and wherein (iv) further comprises requiring the OFR and CM pairs in the filtered file to have charge magnitude standard deviations less than a first threshold, and requiring the OFR and CM pairs in the recovery file to have charge magnitude standard deviations greater than the first threshold.

A fifth aspect includes the features of the first or the second aspect, and may further comprise executing (iv) for each of the OFR and CM pairs in the recovery file.

A sixth aspect includes the features of any of the first through fifth aspects, and wherein (iv) comprises: collecting charge magnitudes for all OFR and CM pairs in the filtered file that have an oscillation frequency in the ELIT or orbitrap within the frequency window of the oscillation frequency in the ELIT or orbitrap of the OFR and CM pair in the recovery file, randomly selecting one of the collected charge magnitudes, and modifying the charge magnitude of the OFR and CM pair in the recovery file as a function of the randomly selected charge magnitude.

A seventh aspect includes the features of the sixth aspect, and wherein modifying the charge magnitude comprises: modifying the charge magnitude of the randomly selected one of the collected charge magnitudes by adding a noise value thereto, and replacing the charge magnitude of the OFR and CM pair in the recovery file with the modified charge magnitude.

An eighth aspect includes the features of any of the first through seventh aspects, and wherein (ii) further comprises excluding from the set of OFR and CM pairs all OFR and CM value pairs for ions that were not trapped in the ELIT or orbitrap for a full duration of the ion trapping event.

A ninth aspect includes the features of any of the third through eighth aspects, and wherein (ii) further comprises determining an oscillation frequency standard deviation for each of the OFR and CM pairs, and wherein (iii) further comprises excluding from each of the filtered file and the recovery file all OFR and CM pairs in the set of OFR and CM pairs having an oscillation frequency standard deviation that is greater than a second threshold.

A tenth aspect includes the features of the ninth aspect, and wherein (ii) further comprises: computing a series of short-time overlapping Fourier transforms (STFTs) stepped sequentially through the collected charge detection data, and determining the set of OFR and CM pairs, and the charge magnitude and oscillation frequency standard deviations for each of the OFR and CM pairs, from the STFTs.

An eleventh aspect includes the features of the first aspect, and may further comprise, between (i) and (ii): collecting charge detection data resulting from detection of charges induced by the multiple ions on the charge detector over the ion trapping event, and computing a series of short-time overlapping Fourier transforms (STFTs) stepped sequentially through the collected charge detection data, the STFTs including STFT frequency values and STFT charge values, and wherein (ii) comprises determining the set of OFR and CM pairs, from the STFT frequency values and the STFT charge values.

A twelfth aspect includes the features of the eleventh aspect, and wherein the recovery file comprises a first recovery file, and wherein (iii) further comprises forming a second recovery file from the set of OFR and CM pairs, the second recovery file including OFR and CM pairs having oscillation frequencies that overlap with oscillation frequencies of other OFR and CM pairs, wherein the overlapping oscillation frequencies in the second recovery file are indiscernible from one another, and wherein the method further comprises the following between (iv) and (v): (vi) for at least one of the OFR and CM pairs in the second recovery file, (a) determining first and second OFR values as a function of the STFT charge and frequency values for the OFR and CM pair, and (b) modifying the second recovery file by replacing the OFR and CM pair in the second recovery file with first and second OFR and CM pairs, the first OFR and CM pair having the determined first OFR value and the charge magnitude of the OFR and CM pair, and the second OFR and CM pair having the determined second OFR value and the charge magnitude of the OFR and CM pair.

A thirteenth aspect includes the features of the twelfth aspect, and may further comprise executing (vi) for each of the OFR and CM pairs in the second recovery file.

A fourteenth aspect includes the features of the twelfth or thirteenth aspect, and may further comprise the following after (vi) and between (iv) and (v): (viii) for each OFR and CM pair in the modified second recovery file (a) modifying the charge magnitude of the OFR and CM pair as a function of the charge magnitude of one of the OFR and CM pairs in the filtered file having an oscillation frequency in the ELIT or orbitrap that is within a frequency window of an oscillation frequency in the ELIT or orbitrap of the OFR and CM pair, and (b) updating the filtered file by adding the OFR and CM pair, with the modified charge magnitude, to the filtered file.

A fifteenth aspect includes the features of any of the twelfth through fourteenth aspects, and wherein (vi) comprises determining the first and second OFR values as a function of the STFT charge and frequency values for the selected OFR and CM pair by: (1) determining a center frequency from a mode of the STFT frequency values for the selected OFR and CM pair, (2) fitting a sine function to the STFT charge values for the selected OFR and CM pair to determine a frequency difference, (3) adding one half of the frequency difference to the center frequency to determine the first OFR value, and (4) subtracting one half of the frequency difference from the center frequency to determine the second OFR value.

A sixteenth aspect includes the features of any of the twelfth through fifteenth aspects, and wherein forming the second recovery file further comprises processing the STFTs and including in the second recovery file only OFR and CM pairs for which: a variation in respective STFT charge values across the STFTs exceeds a first percentage, the variation in the respective STFT charge values across the STFTs is non-linear in shape, and less than a second percentage of the respective STFT frequencies across the STFTs are within a frequency threshold of the oscillating frequency of the respective OFR and CM pair.

A seventeenth aspect includes the features of any of the twelfth through sixteenth aspects, and may further comprise executing (iv) for each of the OFR and CM pairs in the first recovery file.

An eighteenth aspect includes the features of the fourteenth aspect, and may further comprise executing (i)-(iv), (vi), and (vii) multiple times, followed by executing (v) using the updated filtered file containing OFR and CM pairs for all of the multiple executions of (i)-(iv), (vi) and (vii).

A nineteenth aspect includes the features of any of the first through eighteenth aspects, and wherein (v) comprises determining for each OFR and CM pair in the updated filtered file at least one of a mass-to-charge ratio and a mass of the respective ion, and including in the spectral distribution for each OFR and CM pair in the updated filtered file one or any combination of the respective mass, mass-to-charge ratio, and charge magnitude (CM).

In a twentieth aspect, a method of operating a charge detection mass spectrometer, including an electrostatic linear ion trap (ELIT) or an orbitrap, may comprise (i) trapping multiple ions, generated from a sample, in the ELIT or orbitrap such that the multiple trapped ions oscillate back and forth through or about a charge detector of the ELIT or orbitrap during an ion trapping event, (ii) collecting charge detection data resulting from detection of charges induced by the multiple ions on the charge detector over the ion trapping event, (iii) determining from the collected charge detection data a set of oscillation frequency (OFR) and charge magnitude (CM) pairs each corresponding to a different one of the multiple trapped ions, (iv) forming filtered and recovery files from the set of OFR and CM pairs, the filtered file including OFR and CM pairs from which a spectral distribution of the sample is to be produced, and the recovery file including OFR and CM pairs having oscillation frequencies that overlap with oscillation frequencies of other OFR and CM pairs, wherein the overlapping oscillation frequencies in the recovery file are indiscernible from one another, (v) for at least one of the OFR and CM pairs in the recovery file, (a) determining from the collected charge detection data first and second OFR values for the OFR and CM pair, and (b) modifying the recovery file by replacing the OFR and CM pair in the recovery file with first and second OFR and CM pairs, the first OFR and CM pair having the determined first OFR value and the charge magnitude of the OFR and CM pair, and the second OFR and CM pair having the determined second OFR value and the charge magnitude of the OFR and CM pair, (vi) for each OFR and CM pair in the modified recovery file (a) modifying the charge magnitude of the OFR and CM pair as a function of the charge magnitude of one of the OFR and CM pairs in the filtered file having an oscillation frequency in the ELIT or orbitrap that is within a frequency window of an oscillation frequency in the ELIT or orbitrap of the OFR and CM pair, and (b) updating the filtered file by adding the OFR and CM pair, with the modified charge magnitude, to the filtered file, and (vii) producing a spectral distribution of the sample from the updated filtered file.

A twenty first aspect includes the features of the twentieth aspect, and may further comprise executing (i)-(vi) multiple times, followed by executing (vii) using the updated filtered file containing OFR and CM pairs for all of the multiple executions of (i)-(vi).

A twenty second aspect includes the features of the twentieth aspect or the twenty first aspect, and wherein (v)(a) comprises: collecting charge magnitudes for all OFR and CM pairs in the filtered file that have an oscillation frequency in the ELIT or orbitrap within the frequency window of the oscillation frequency in the ELIT or orbitrap of the OFR and CM pair in the recovery file, randomly selecting one of the collected charge magnitudes, and modifying the charge magnitude of the OFR and CM pair in the recovery file as a function of the randomly selected charge magnitude.

A twenty third aspect includes the features of the twenty second aspect, and wherein modifying the charge magnitude comprises: modifying the charge magnitude of the randomly selected one of the collected charge magnitudes by adding a noise value thereto, and replacing the charge magnitude of the respective OFR and CM pair with the modified charge magnitude.

A twenty fourth aspect includes the features of any of the twentieth through twenty third aspects, and wherein (iii) further comprises excluding from the set of OFR and CM pairs all OFR and CM value pairs for ions that were not trapped in the ELIT or orbitrap for a full duration of the ion trapping event.

A twenty fifth aspect includes the features of the any of the twentieth through twenty fourth aspects, and wherein (iii) further comprises: computing a series of short-time overlapping Fourier transforms (STFTs) stepped sequentially through the collected charge detection data, the STFTs including STFT charge values and STFT frequency values, and determining from the STFT charge and frequency values an oscillation frequency standard deviation for each of the OFR and CM pairs.

A twenty sixth aspect includes the features of the twenty fifth aspect, and wherein (iv) further comprises excluding from the filtered file and from the recovery file all OFR and CM pairs in the set of OFR and CM pairs having an oscillation frequency standard deviation that is greater than a second threshold.

A twenty seventh aspect includes the features of the twenty fifth aspect or the twenty sixth aspect, and wherein (iii) further comprises:
computing a series of short-time overlapping Fourier transforms (STFTs) stepped sequentially through the collected charge detection data, the STFTs including STFT charge values and STFT frequency values, and determining from the STFT charge and frequency values a charge magnitude standard deviation for each of the OFR and CM pairs, and wherein (iv) further comprises requiring the OFR and CM pairs in the filtered file to have charge magnitude standard deviations less than a first threshold, and requiring the OFR and CM pairs in the recovery file to have charge magnitude standard deviations greater than the first threshold.

A twenty eighth aspect includes the features of any of the twentieth through twenty seventh aspects, and may further comprise executing (vi) for each of the OFR and CM pairs in the recovery file.

A twenty ninth aspect includes the features of any of the twenty fifth through twenty eighth aspects, and wherein (iii) comprises determining the set of OFR and CM pairs from the STFT charge and frequency values, and wherein (v)(a) comprises determining the first and second OFR values for the OFR and CM pair as a function of the STFT charge values and STFT frequency values.

A thirtieth aspect includes the features of any of the twenty fifth through twenty ninth aspects, and wherein (v)(a) comprises determining the first and second OFR values as a function of the STFT charge and frequency values for the selected OFR and CM pair by: (1) determining a center frequency from a mode of the STFT frequency values for the selected OFR and CM pair, (2) fitting a sine function to the STFT charge values for the selected OFR and CM pair to determine a frequency difference, (3) adding one half of the frequency difference to the center frequency to determine the first OFR value, and (4) subtracting one half of the frequency difference from the center frequency to determine the second OFR value.

A thirty first aspect includes the features of the twenty ninth aspect or the thirtieth aspect, and wherein forming the recovery file further comprises processing the STFTs and including in the recovery file only OFR and CM pairs for which: a variation in respective STFT charge values across the STFTs exceeds a first percentage, the variation in the respective STFT charge values across the STFTs is non-linear in shape, and less than a second percentage of the respective STFT frequencies across the STFTs are within a frequency threshold of the oscillating frequency of the respective OFR and CM pair.

A thirty second aspect includes the features of any of the twentieth through thirty first aspects, and wherein (vii) comprises determining for each OFR and CM pair in the updated filtered file at least one of a mass-to-charge ratio and a mass of the respective ion, and including in the spectral distribution for each OFR and CM pair in the updated filtered file one or any combination of the respective mass, mass-to-charge ratio, and charge magnitude (CM).

In a thirty third aspect, a method of operating a charge detection mass spectrometer, including an electrostatic linear ion trap (ELIT) or an orbitrap, may comprise (i) trapping multiple ions, generated from a sample, in the ELIT or orbitrap such that the multiple trapped ions oscillate back and forth through or about a charge detector of the ELIT or orbitrap during an ion trapping event, (ii) collecting charge detection data resulting from detection of charges induced by the multiple ions on the charge detector over the ion trapping event, (iii) determining from the collected charge detection data a set of oscillation frequency (OFR) and charge magnitude (CM) pairs each corresponding to a different one of the multiple trapped ions, (iv) forming a filtered file and first and second recovery files from the set of OFR and CM pairs, the filtered file including OFR and CM pairs from which a spectral distribution of the sample is to be produced, the first and second recovery files each including OFR and CM pairs having oscillation frequencies that overlap with oscillation frequencies of other OFR and CM pairs, wherein the overlapping oscillation frequencies in the first recovery file are discernible from one another, and the overlapping oscillation frequencies in the second recovery file are indiscernible from one another, (v) for at least one of the OFR and CM pairs in the first recovery file, (a) modifying the charge magnitude of the OFR and CM pair as a function of the charge magnitude of one of the OFR and CM pairs in the filtered file having an oscillation frequency in the ELIT or orbitrap that is within a frequency window of an oscillation frequency in the ELIT or orbitrap of the OFR and CM pair, and (b) updating the filtered file by adding the OFR and modified CM pair thereto, (vi) for at least one of the OFR and CM pairs in the second recovery file, (a) determining from the collected charge detection data first and second OFR values for the OFR and CM pair, and (b) modifying the second recovery file by replacing the OFR and CM pair in the second recovery file with first and second OFR and CM pairs, the first OFR and CM pair having the determined first OFR value and the charge magnitude of the OFR and CM pair, and the second OFR and CM pair having the determined second OFR value and the charge magnitude of the OFR and CM pair, (vii) for each OFR and CM pair in the modified second recovery file (a) modifying the charge magnitude of the OFR and CM pair as a function of the charge magnitude of one of the OFR and CM pairs in the filtered file having an oscillation frequency in the ELIT or orbitrap that is within a frequency window of an oscillation frequency in the ELIT or orbitrap of the OFR and CM pair, and (b) updating the filtered file by adding the OFR and CM pair, with the modified charge magnitude, to the filtered file, and (viii) producing a spectral distribution of the sample from the updated filtered file.

A thirty fourth aspect includes the features of the thirty third aspect, and may further comprise executing (i)-(vii) multiple times, followed by executing (viii) using the updated filtered file containing OFR and CM pairs for all of the multiple executions of (i)-(vii).

A thirty fifth aspect includes the features of the thirty third aspect or the thirty fourth aspect, and may further comprise executing (v) for each of the OFR and CM pairs in the first recovery file.

A thirty sixth aspect includes the features of any of the thirty third through thirty fifth aspects, and may further comprise executing (vi) for each of the OFR and CM pairs in the second recovery file.

A thirty seventh aspect includes the features of any of the thirty third through thirty sixth aspects, and wherein (iii) further comprises: computing a series of short-time overlapping Fourier transforms (STFTs) stepped sequentially through the collected charge detection data, the STFTs including STFT charge values and STFT frequency values, and determining from the STFT charge and frequency values a charge magnitude standard deviation for each of the OFR and CM pairs, and wherein (iv) further comprises requiring the OFR and CM pairs in the filtered file to have charge magnitude standard deviations less than a first threshold, and requiring the OFR and CM pairs in each of the first and second recovery files to have charge magnitude standard deviations greater than the first threshold.

A thirty eighth aspect includes the features of any of the thirty third through thirty seventh aspects, and wherein (iv) further comprises excluding from the set of OFR and CM pairs all OFR and CM value pairs for ions that were not trapped in the ELIT or orbitrap for a full duration of the ion trapping event.

A thirty ninth aspect includes the features of any of the thirty third through thirty eighth aspects, and wherein (iii) further comprises: computing a series of short-time overlapping Fourier transforms (STFTs) stepped sequentially through the collected charge detection data, the STFTs including STFT charge values and STFT frequency values, and determining from the STFT charge and frequency values an oscillation frequency standard deviation for each of the OFR and CM pairs, and wherein (iv) further comprises excluding from the filtered file and from each of the first and second recovery files all OFR and CM pairs in the set of OFR and CM pairs having an oscillation frequency standard deviation that is greater than a second threshold.

A fortieth aspect includes the features of any of the thirty third through thirty ninth aspect, and wherein (v)(a) comprises: collecting charge magnitudes for all OFR and CM pairs in the filtered file that have an oscillation frequency in the ELIT or orbitrap within the frequency window of the oscillation frequency in the ELIT or orbitrap of the OFR and CM pair in the first recovery file, randomly selecting one of the collected charge magnitudes, and modifying the charge magnitude of the OFR and CM pair in the first recovery file as a function of the randomly selected charge magnitude.

A forty first aspect includes the features of the fortieth aspect, and wherein modifying the charge magnitude comprises: modifying the charge magnitude of the randomly selected one of the collected charge magnitudes by adding a noise value thereto, and replacing the charge magnitude of the OFR and CM pair in the first recovery file with the modified charge magnitude.

A forty second aspect includes the features of any of the thirty third through forty first aspects, and wherein (iii) comprises: computing a series of short-time overlapping Fourier transforms (STFTs) stepped sequentially through the collected charge detection data, the STFTs including STFT charge values and STFT frequency values, and determining the set of OFR and CM pairs from the STFT charge and frequency values.

A forty third aspect includes the features of the forty second aspect, and wherein (vi)(a) comprises determining the first and second OFR values as a function of the STFT charge and frequency values for the selected OFR and CM pair by: (1) determining a center frequency from a mode of the STFT frequency values for the selected OFR and CM pair, (2) fitting a sine function to the STFT charge values for the selected OFR and CM pair to determine a frequency difference, (3) adding one half of the frequency difference to the center frequency to determine the first OFR value, and (4) subtracting one half of the frequency difference from the center frequency to determine the second OFR value.

A forty fourth aspect incudes the features of the forty second aspect or the forty third aspect, and wherein forming the second recovery file further comprises processing the STFTs and including in the second recovery file only OFR and CM pairs for which: a variation in respective STFT charge values across the STFTs exceeds a first percentage, the variation in the respective STFT charge values across the STFTs is non-linear in shape, and less than a second percentage of the respective STFT frequencies across the STFTs are within a frequency threshold of the oscillating frequency of the respective OFR and CM pair.

A forty fifth aspect includes the features of any of the thirty third through forty fourth aspects, and wherein (vii) (a) comprises: collecting charge magnitudes for all OFR and CM pairs in the filtered file that have an oscillation frequency in the ELIT or orbitrap within the frequency window of the oscillation frequency in the ELIT or orbitrap of the OFR and CM pair in the modified second recovery file, randomly selecting one of the collected charge magnitudes, and modifying the charge magnitude of the OFR and CM pair in the modified second recovery file as a function of the randomly selected charge magnitude.

A forty sixth aspect includes the features of the forty fifth aspect, and wherein modifying the charge magnitude comprises: modifying the charge magnitude of the randomly selected one of the collected charge magnitudes by adding a noise value thereto, and replacing the charge magnitude of the OFR and CM pair in the modified second recovery file with the modified charge magnitude.

A forty seventh aspect includes the features of any of the thirty third through forty sixth aspects, and wherein (viii) comprises determining for each OFR and CM pair in the updated filtered file at least one of a mass-to-charge ratio and a mass of the respective ion, and including in the spectral distribution for each OFR and CM pair in the updated filtered file one or any combination of the respective mass, mass-to-charge ratio, and charge magnitude (CM).

### BRIEF DESCRIPTION OF THE DRAWINGS

FIG. 1 is a simplified side-view diagram of a charged detection mass spectrometer (CDMS) including an embodiment of an electrostatic linear ion trap (ELIT) with control and measurement components coupled thereto.

FIG. 2 is a simplified side-view diagram of an example embodiment of the ion source of the CDMS illustrated in FIG. 1.

FIG. 3 is a simplified diagram of an embodiment of the processor illustrated in FIG. 1.

FIGS. 4A-4C are simplified side-view diagrams of the ELIT of FIG. 1 demonstrating sequential control and operation of the ion mirrors to capture ions within the ELIT and to cause the ions to oscillate back and forth between the ion mirrors each time passing through the charge detection cylinder during which charge detection data of the ions is measured and recorded for the duration of an ion trapping event.

FIG. 5 is a flowchart illustrating an example process for processing time-based charge detection data (CDD) resulting from simultaneous trapping of and measurement of multiple charged particles in the ELIT of the CDMS of FIG. 1.

FIG. 6 is a flowchart illustrating an example process for conduct a quality check of oscillating frequency and charge magnitude pair values determined by the process of FIG. 5.

FIG. 7 is a flowchart illustrating an embodiment of a charged particle recovery process executed at step 120 in some embodiments of the process of FIG. 5.

FIG. 8 includes panels 8a), 8b), 8c), and 8d), and shows full-event FFTs and corresponding STFTs for ions with oscillation frequencies separated by 50 Hz (panels 8a) and 8b)), and for ions with oscillation frequencies separated by 10 Hz (panels 8c) and 8d)).

FIG. 9 includes panels 9a), 9b), 9c), and 9d), and shows two waveforms 180° out of phase with one another (panels 9a) and 9b)) respectively), the two waveforms overlaid (panel 9c)), and the two waveforms combined (panel 9d)).

FIG. 10 is a plot of charge magnitude vs. STFT windows stepped across the time domain data of FIG. 9 demonstrating a frequency beat pattern resulting from the two signals of FIGS. 9a) and 9b) moving in and out of phase with one another.

FIG. 11 is a flowchart illustrating an embodiment of a charged particle recovery process executed at step 122 in some embodiments of the process of FIG. 5.

FIG. 12 includes panels 12a), 12b), 12c), and 12d), and shows mass distributions for a sample of L-glutamate dehydrogenase (GDH) with and without the charged particle recovery process of FIG. 7 and at different measurement rates.

FIG. 13 is a plot of relative intensities of GDH monomer, dimer, and trimer vs. measurement rate with and without the charged particle recovery process of FIG. 7.

FIG. 14 includes panels 14a), 14b), 14c), and 14d), and shows mass distributions for a sample of QB virus-like particles) with and without the charged particle recovery process of FIG. 7 and at different measurement rates.

FIG. 15 includes panels 15a) and 15b), and shows relative abundances of AAV8 ions in different mass bands before (FIG. 15a)) and after (FIG. 15b)) the charged particle recovery process of FIG. 7.

FIG. 16 includes panels 16a) and 16b). Panel 16a) compares mass distributions for a sample of L-glutamate dehydrogenase (GDH) without any charged particle recovery process, with the charged particle recovery process of FIG. 7, and with the charged particle recovery process of FIG. 11. Panel 16d) compares relative measurement intensity using the charged particle recovery process of FIG. 11 at different measurement rates.

### DESCRIPTION OF THE ILLUSTRATIVE EMBODIMENTS

For the purposes of promoting an understanding of the principles of this disclosure, reference will now be made to a number of illustrative embodiments shown in the attached drawings and specific language will be used to describe the same.

This disclosure relates to systems and methods simultaneously analyzing multiple charged particles with a charge detection mass spectrometer (CDMS), and in particular to determining, in such systems, charge magnitudes and/or oscillation frequencies of trapped charged particles with overlapping oscillation frequencies. The charge magnitudes and oscillation frequencies of some such trapped charged particles, which may otherwise be purposefully omitted from the results of the analysis due to measurement inaccuracies relating to the overlap of oscillation frequencies of two or more of the trapped charged particles, may now be included in the analysis results as described below to provide for improved spectral distribution accuracy. For purposes of this disclosure, the phrase “charged particle detection event” is defined as detection of a charge induced on a charge detector of an electrostatic linear ion trap (ELIT) or an orbitrap by a charged particle passing a single time through or about the charge detector. In CDMS instruments in which multiple charged particles are trapped for simultaneous analysis in an ELIT or orbitrap, as is the case for the CDMS instruments disclosed herein, charged particle detection events, as just defined, occur for each of the multiple trapped charged particles. The phrase “charged particle measurement event” is defined as a collection of charged particle detection events resulting from oscillation of the multiple charged particles back and forth through or about the charge detector a selected number of times or for a selected time period. As such back and forth oscillation of charged particles results from controlled trapping of the multiple charged particles within the ELIT or orbitrap, as will be described in detail below, the phrase “charged particle measurement event” may alternatively be referred to herein as a “charged particle trapping event” or simply as an “ion trapping event” or a “trapping event,” and the phrases “charged particle measurement event,” “charged particle trapping event”, “ion trapping event,” “trapping event” and variants thereof shall be understood to be synonymous with one another. For purposes of this disclosure, the terms “ion” and “charged particle,” and variations thereof, will be understood to be synonymous. The term “ion” may thus be substituted for the term “charged particle” in any of the above definitions.

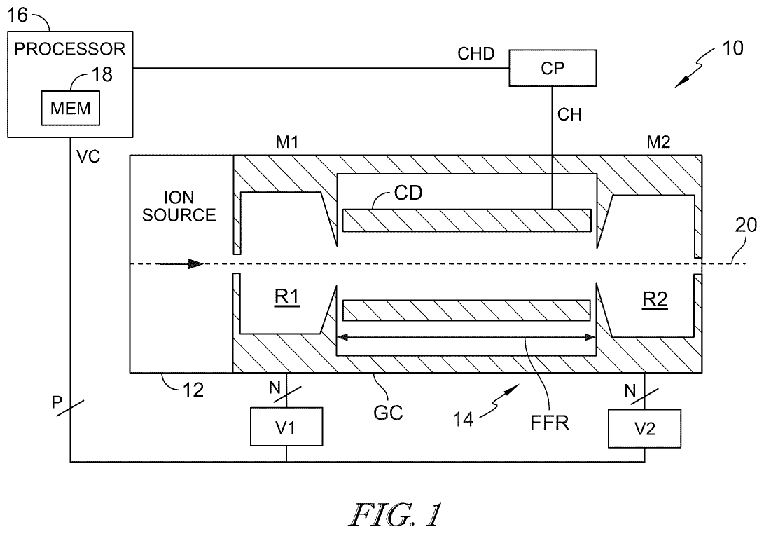

Referring to FIG. 1, an embodiment is shown of a charge detection mass spectrometer (CDMS) 10 illustratively including an electrostatic linear ion trap (ELIT) 14 as a charged particle detector. In some alternate embodiments, a conventional orbitrap may be used as the charged particle detector in place of the ELIT 14, and one non-limiting example of such an orbitrap is disclosed in WO 2020/106310A1, the disclosure of which is expressly incorporated herein by reference in its entirety. In any case, in the operation of the CDMS 10, as will be described in detail below, multiple charged particles are simultaneously trapped, and simultaneously analyzed, in and by the ELIT 14 (or orbitrap).

The CDMS 10 illustrated by example in FIG. 1 further includes a charged particle source 12 operatively coupled to the ELIT 14, wherein the charged particle source 12 and the ELIT 14 together illustratively define a longitudinal axis 20 extending centrally therethrough. The charged particle source 12 illustratively includes any conventional device or apparatus for generating charged particles from a sample and may further include one or more devices and/or instruments for guiding, separating, collecting, filtering, controlling/setting energy, fragmenting and/or normalizing or shifting charge states of the generated charged particles according to one or more molecular characteristics. By example, which should not be considered to be limiting in any way, the device or apparatus for generating charged particles from a sample may be or include a conventional electrospray ionization source, a matrix-assisted laser desorption ionization (MALDI) source or the like. In some embodiments, the charged particle source 12 may further include a conventional mass spectrometer having a charged particle inlet configured to receive the generated charged particles. If included, the mass spectrometer may be of any conventional design including, for example, but not limited to a time-of-flight (TOF) mass spectrometer, an orthogonal acceleration TOF mass spectrometer, a reflectron mass spectrometer, a Fourier transform ion cyclotron resonance (FTICR) mass spectrometer, a quadrupole mass spectrometer, a triple quadrupole mass spectrometer, a magnetic sector mass spectrometer, orbitrap, or the like. In such embodiments, the charged particle source 12 may further include one or more devices and/or instruments between the device or apparatus for generating charged particles and the mass spectrometer and/or between the mass spectrometer and the ELIT 14 for guiding, separating, collecting, filtering, controlling/setting energy, fragmenting and/or normalizing or shifting charge states of the generated charged particles according to one or more molecular characteristics. In embodiments which do not include a mass spectrometer, the charged particle source 12 may include one or more devices and/or instruments between the device or apparatus for generating charged particles and the ELIT 14 for guiding, separating, collecting, filtering, controlling/setting energy, fragmenting and/or normalizing or shifting charge states of the generated charged particles according to one or more molecular characteristics. In any case, the sample from which the charged particles are generated may be or include any biological or other material or combination of materials.

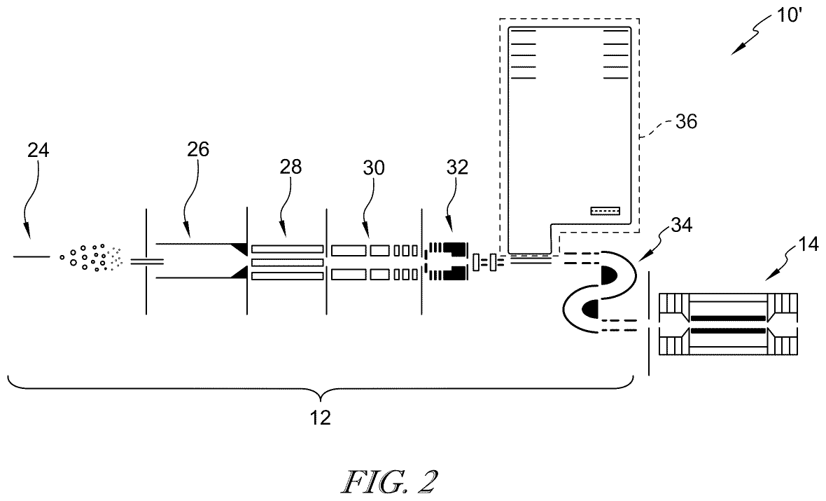

Referring now to FIG. 2, a CDMS 10′ is shown which includes an example embodiment of the ion source 12 of the CDMS 10 operatively coupled to the ELIT 14, and thus represents a non-limiting example embodiment of the CDMS 10 illustrated in FIG. 1. In the example embodiment illustrated in FIG. 2, the ion source 12 illustratively includes a conventional electrospray ionization source 24 having a charged particle outlet positioned to supply charged particles to a charged particle inlet of a conventional charged particle interface 26 configured to guide charged particles from a region of high pressure, e.g., atmospheric pressure, in which the ionization source 24 resides to a region of lower pressure, e.g., a vacuum condition, of a downstream stage 28 of the ion source 12. Non-limiting examples of such a charged particle interface 26 is disclosed in WO 2019/236139A1 and WO 2019/236572A1, the disclosures of which are both expressly incorporated herein by reference in their entireties.

In the embodiment depicted in FIG. 2, the stage 28 of the ion source 12 is illustratively implemented in the form of a conventional RF-only hexapole. The RF-only hexapole 28 has a charged particle inlet operatively coupled to a charged particle outlet of the charged particle interface 26, and a charged particle outlet operatively coupled to a charged particle inlet of a downstream stage 30. Operation of the RF-only hexapole 28 is conventional and acts to guide charged particles axially through hexapole 28 from the charged particle inlet to charged particle outlet thereof while also radially focusing and confining the charged particle to and about the longitudinal axis 20 defined centrally through the ion source 12 (see FIG. 1).

Stage 30 of the ion source 12 of FIG. 2 is illustratively implemented in the form of a conventional RF-only quadrupole. The RF-only quadrupole 30 has a charged particle inlet operatively coupled to a charged particle outlet of the hexapole 28, and a charged particle outlet operatively coupled to a charged particle inlet of a downstream stage 32. Operation of the RF-only quadrupole 30 is conventional and acts to guide charged particles axially through quadrupole 30 from the charged particle inlet to charged particle outlet thereof while also radially focusing and confining the charged particle about the longitudinal axis 20 defined centrally through the ion source 12 (see FIG. 1). In some, but not necessarily all, embodiments, the RF-only quadrupole 30 may be controlled as described in co-pending International Application No. PCT/US2023/073710, the disclosure of which is expressly incorporated herein by reference in its entirety, to eliminate, or at least reduce, the effects of “noding” associated with otherwise conventional operation of an RF-only quadrupole, wherein the term “noding” refers, in the context of FIG. 2, to off-axis exit of charged particles from the charged particle outlet of the RF-only quadrupole 30, resulting in angular deviation from the central, longitudinal axis 20 of at least some of the charged particles exiting the charged particle outlet of the quadrupole 30 and as the charged particles move away from the charged particle outlet of the quadrupole 30.

The stage 32 of the ion source 12 of FIG. 2 is illustratively implemented in the form of conventional charged particle focusing optics. Charged particles passing through the optics 32 are focused into a charged particle inlet of a conventional dual-hemisphere energy analyzer 34 having a charged particle outlet operatively coupled to, or otherwise aligned with, a charged particle inlet of the ELIT 14. The energy analyzer 34 illustratively operates to transmit to the ELIT 14 only charged particles having ion energies in a narrow band of ion energies. In one embodiment in which the ELIT 14 is provided in the form described by example below, the energy analyzer 34 is configured to transmit only charged particles having ion energies in a narrow band of energies centered around approximately 130 eV/z, although it will be understood that in other embodiments the energy analyzer 34 may be configured to transmit charged particles centered around a band or window of energies of any desired size and/or centered around other charged particle energy values, i.e., other than 130 eV/z.

In the embodiment illustrated in FIG. 2, multiple charged particles are fed from the focusing optics 32 directly into the ELIT 14 via the energy analyzer 34. In some alternate embodiments, a mass spectrometer 36 may be interposed between the focusing optics 32 and the energy analyzer 34 to provide for separation of charged particles as a function of mass-to-charge ratio, m/z, prior to entrance into the ELIT 14, as depicted by dashed-line representation in FIG. 2. In one example embodiment, the mass spectrometer 36 may be a conventional orthogonal acceleration TOF mass spectrometer, although in other embodiments which include it, the mass spectrometer 36 may take other conventional forms, some examples of which are described above with respect to FIG. 1.

Referring again to FIG. 1, the ELIT 14 depicted by example illustratively includes a charge detector CD, surrounded by a ground chamber or cylinder GC, and operatively coupled to opposing ion mirrors M1, M2 respectively positioned at opposite ends of the charged detector CD. The ion mirrors M1, M2 may alternatively be referred to herein as “endcaps” or “end caps,” it being understood that the terms ion mirror and endcap (or end cap) are, for purposes of this disclosure, synonymous. The ion mirror M1 is operatively positioned between the charged particle outlet of the charged particle source 12 and one end of the charge detector CD, and the ion mirror M2 is operatively positioned at the opposite end of the charge detector CD. Each ion mirror M1, M2 defines a respective ion mirror region R1, R2 therein. The regions R1, R2 of the ion mirrors M1, M2, the charge detector CD, and the spaces between the charge detector CD and the ion mirrors M1, M2 are axially aligned such that together they define the longitudinal axis 20 centrally therethrough which illustratively represents an ideal ion travel path through the ELIT 14 and between the ion mirrors M1, M2 as will be described in greater detail below. The region defined axially between the opposed inner surfaces of the ion mirrors M1, M2, i.e., in which the charge detector CD is positioned, illustratively defines a field-free region FFR, i.e., in which no electric field is established during the operation of the ELIT 14.

In the illustrated embodiment, voltage sources V1, V2 are electrically coupled to the ion mirrors M1, M2, respectively. Each voltage source V1, V2 illustratively includes one or more switchable DC voltage sources which may be controlled or programmed to selectively produce a number, N, programmable or controllable voltages, wherein N may be any positive integer. Such voltages may illustratively be programmed to establish each of two different operating modes of each of the ion mirrors M1, M2 as will be described in detail below. In any case, the ELIT 14 is designed such that charged particles move within the ELIT 14 close to the longitudinal axis 20 under the influence of electric fields selectively established in the ion mirrors M1, M2 by the voltage sources V1, V2.

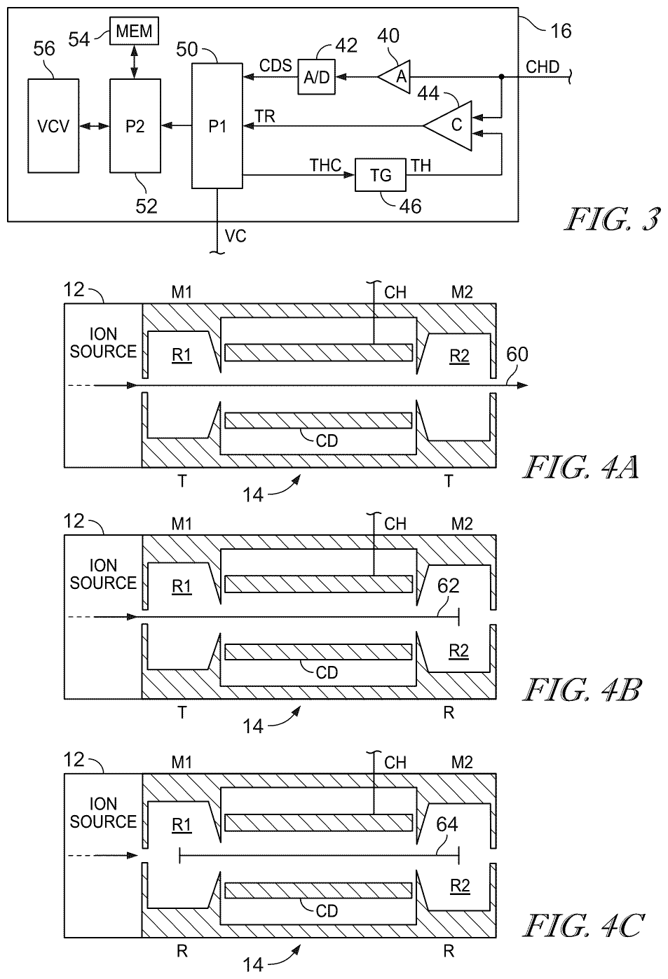

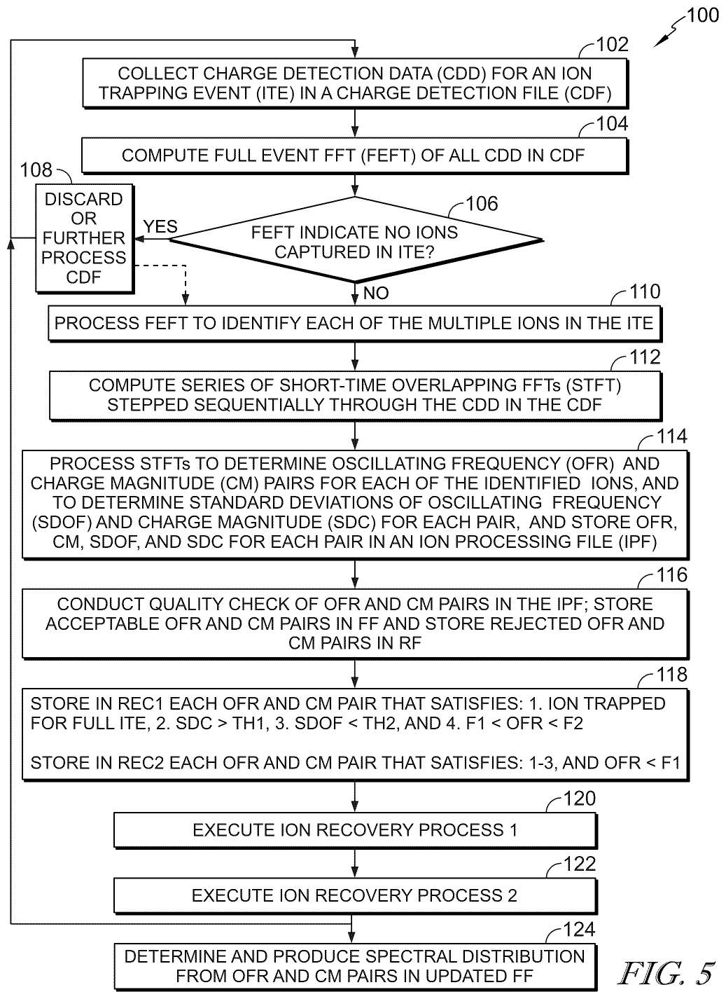

The voltage sources V1, V2 are illustratively shown electrically connected by a number, P, of signal paths to a conventional processor 16 including a memory 18 having instructions stored therein which, when executed by the processor 16, cause the processor 16 to control the voltage sources V1, V2 to produce desired DC output voltages for selectively establishing ion transmission and ion reflection electric fields, T, R respectively, within the regions R1, R2 of the respective ion mirrors M1, M2 (see, e.g., FIGS. 4A-4C). P may be any positive integer. In some alternate embodiments, either or both of the voltage sources V1, V2 may alternatively or additionally be programmable to selectively produce one or more constant output voltages. In other alternative embodiments, either or both of the voltage sources V1, V2 may be configured to produce one or more time-varying output voltages of any desired shape. It will be understood that more or fewer voltage sources may be electrically connected to the mirrors M1, M2 in alternate embodiments. In any case, the ion mirrors M1, M2 are, in some embodiments, constructed with a number of axially spaced-apart electrically conductive electrodes or rings.

Voltage outputs of the voltage source V1 are electrically connected to respective ones of the electrically conductive electrodes of the ion mirror M1, and voltage outputs of the voltage source V2 are electrically connected to respective ones of the electrically conductive electrodes of the ion mirror M2, and the various voltage outputs of the voltage sources V1, V2 are controlled in a conventional manner to selectively establish the ion transmission and ion reflection electric fields (T, R) within the respective regions R1, R2 of the ion mirrors M1, M2. Each ion mirror M1, M2 is illustratively controllable and switchable, by selective application of the voltages produced by the voltage sources V1, V2, between the ion transmission mode, in which the voltages produced by the respective voltage source V1, V2 establish the ion transmission electric field (T) in the respective region R1, R2 thereof, and an ion reflection mode in which the voltages produced by the respect voltage source V1, V2 establish the ion reflection electric field (R) in the respective region R1, R2 thereof.

The charge detector CD is illustratively provided in the form of an electrically conductive cylinder, illustratively referred to herein as a charge detection cylinder, which is electrically connected to a signal input of a charge sensitive preamplifier CP, and the signal output of the charge-sensitive preamplifier CP is electrically coupled to the processor 16. In embodiments in which the charged particle detector is implemented in the form of an orbitrap, as described above, the charge detector CD may illustratively be provided in the form of an electrically conductive spindle assembly about which ions oscillate in a conventional manner. In any case, referring again to FIG. 1, the voltage sources V1, V2 are illustratively controlled in a manner, which selectively traps in the ELIT 14 multiple charged particles entering the charged particle inlet of the ELIT 14 and causes each of the multiple trapped charged particles to oscillate with the ELIT 14 back and forth between the ion mirrors M1, M2 each time passing axially through the charge detection cylinder CD. An ion transmission electric field, T, established in an ion mirror M1, M2, for example, illustratively operates to focus charged particles toward the longitudinal axis 20 of the ELIT 14 as the charged particles pass through the ion mirror M1, M2. An ion reflection electric field, R, established in an ion mirror M1, M2, in contrast, illustratively acts to decelerate and stop charged particles entering the ion mirror M1, M2 from the charge detection cylinder CD, and to then accelerate the stopped charged particle in the opposite direction back into the respective end of the charge detection cylinder CD, and to focus the charged particles toward the central, longitudinal axis 20. By selectively establishing the ion transmission and ion reflection electric fields (T, R respectively) in the ion mirrors M1, M2, multiple ions can be trapped in the ELIT 14 and made to oscillate back and forth between the ion mirrors M1, M2, each time passing through the charge detection cylinder CD and inducing respective charges on the charge detection cylinder CD which are detected by the charge sensitive preamplifier CP. Thus, with multiple charged particles trapped within the ELIT 14 and oscillating back and forth between the ion mirrors M1, M2, the charge sensitive preamplifier CP is illustratively operable in a conventional manner to detect charges (CH) respectively induced on the charge detection cylinder CD as each of the multiple charged particles repeatedly pass through the charge detection cylinder CD between the ion mirrors M1, M2, and to produce charge detection signals (CHD) corresponding thereto. Further details relating to the structure and operation of an example embodiment of the ion mirrors M1, M2, and of the ELIT 14, are disclosed in WO 2019/140233, the disclosure of which is expressly incorporated herein in its entirety.

The charge detection signals CHD are illustratively periodic and are recorded in the form of amplitude and period values and, in this regard, each amplitude and period pair represents ion measurement information for a charge detection event in which a respective one of the multiple charged particles is traveling through the charge detection cylinder CD. The amplitude is the amplitude of the charge induced by the charged particle on the charge detection cylinder as the charged particle passes therethrough, and the period value is the time duration of passage of the charged particle through the charge detection cylinder. A plurality of such amplitude and period values are measured and recorded during a respective charged particle measurement event (i.e., during a charged particle trapping event), and the resulting plurality of recorded values i.e., the collection of recorded charged particle measurement information, for the charged particle measurement event, is processed to determine mass-to-charge ratios (m/z) and charge magnitudes of each of the multiple charged particles, as will be described below. Charged particle mass values are then computed based on the m/z and corresponding charge magnitude values. Multiple charged particle measurement events can be processed in this manner, and a mass-to-charge ratio and/or mass and/or charge spectrum of the sample may illustratively be constructed therefrom in a conventional manner.

Referring now to FIG. 3, an embodiment is shown of the processor 16 illustrated in FIG. 1. In the illustrated embodiment, the processor 16 includes a conventional amplifier circuit 40 having an input receiving the charge detection signal CHD produced by the charge sensitive preamplifier CP and an output electrically connected to an input of a conventional Analog-to-Digital (A/D) converter 42. An output of the A/D converter 42 is electrically connected to a processor 50 (P1). The amplifier 40 is operable in a conventional manner to amplify the charge detection signal CHD produced by the charge sensitive preamplifier CP, and the A/D converter 42 is, in turn, operable in a conventional manner to convert the amplified charge detection signal to a digital charge detection signal CDS.

The processor 16 illustrated in FIG. 3 further illustratively includes a conventional comparator 44 having a first input receiving the charge detection signal CHD produced by the charge sensitive preamplifier CP, a second input receiving a threshold voltage CTH produced by a threshold voltage generator (TG) 46 and an output electrically connected to the processor 50. The comparator 44 is operable in a conventional manner to produce a trigger signal TR at the output thereof which is dependent upon the magnitude of the charge detection signal CDH relative to the magnitude of the threshold voltage CTH. In one embodiment, for example, the comparator 44 is operable to produce an “inactive” trigger signal TR at or near a reference voltage, e.g., ground potential, as long as CHD is less than CTH, and is operable to produce an “active” TR signal at or near a supply voltage of the circuitry 40, 42, 44, 46, 50 or otherwise distinguishable from the inactive TR signal when CHD is at or exceeds CTH. In alternate embodiments, the comparator 44 may be operable to produce an “inactive” trigger signal TR at or near the supply voltage as long as CHD is less than CTH, and is operable to produce an “active” trigger signal TR at or near the reference potential when CHD is at or exceeds CTH. Those skilled in the art will recognize other differing trigger signal magnitudes and/or differing trigger signal polarities that may be used to establish the “inactive” and “active” states of the trigger signal TR so long as such differing trigger signal magnitudes and/or different trigger signal polarities are distinguishable by the processor 50, and it will be understood that any such other different trigger signal magnitudes and/or differing trigger signal polarities are intended to fall within the scope of this disclosure. In any case, the comparator 44 may additionally be designed in a conventional manner to include a desired amount of hysteresis to prevent rapid switching of the output between the reference and supply voltages.

The processor 50 is illustratively operable to produce a threshold voltage control signal THC and to supply THC to the threshold generator 46 to control operation thereof. In some embodiments, the processor 50 is programmed or programmable to control production of the threshold voltage control signal THC in a manner which controls the threshold voltage generator 46 to produce CTH with a desired magnitude and/or polarity. In other embodiments, a user may provide the processor 50 with instructions in real time, e.g., through a downstream processor, e.g., via a virtual control and visualization unit 56, to control production of the threshold voltage control signal THC in a manner which controls the threshold voltage generator 46 to produce CTH with a desired magnitude and/or polarity. In either case, the threshold voltage generator 46 is illustratively implemented, in some embodiments, in the form of a conventional controllable DC voltage source configured to be responsive to a digital form of the threshold control signal THC, e.g., in the form of a single serial digital signal or multiple parallel digital signals, to produce an analog threshold voltage CTH having a polarity and a magnitude defined by the digital threshold control signal THC. In some alternate embodiments, the threshold voltage generator 46 may be provided in the form of a conventional digital-to-analog (D/A) converter responsive to a serial or parallel digital threshold voltage TCH to produce an analog threshold voltage CTH having a magnitude, and in some embodiments a polarity, defined by the digital threshold control signals THC. In some such embodiments, the D/A converter may form part of the processor 50. Those skilled in the art will recognize other conventional circuits and techniques for selectively producing the threshold voltage CTH of desired magnitude and/or polarity in response to one or more digital and/or analog forms of the control signal THC, and it will be understood that any such other conventional circuits and/or techniques are intended to fall within the scope of this disclosure.

In addition to the foregoing functions performed by the processor 50, the processor 50 is further operable to control the voltage sources V1, V2 as described above with respect to FIG. 1 to selectively establish ion transmission and reflection fields (T, R respectively) within the regions R1, R2 of the ion mirrors M1, M2, respectively. In some embodiments, the processor 50 is programmed or programmable to control the voltage sources V1, V2. In other embodiments, the voltage source(s) V1 and/or V2 may be programmed or otherwise controlled in real time by a user, e.g., through a downstream processor 52, e.g., via a virtual control and visualization unit. In either case, the processor 50 is, in one embodiment, illustratively provided in the form of a field programmable gate array (FPGA) programmed or otherwise instructed by a user to collect and store charge detection signals CDS for charge detection events and for ion measurement events, to produce the threshold control signal(s) TCH from which the magnitude and/or polarity of the threshold voltage CTH is determined or derived, and to control the voltage sources V1, V2. In this embodiment, the memory 18 described with respect to FIG. 1 is integrated into, and forms part of, the programming of the FPGA. In alternate embodiments, the processor 50 may be provided in the form of one or more conventional microprocessors or controllers and one or more accompanying memory units having instructions stored therein which, when executed by the one or more microprocessors or controllers, cause the one or more microprocessors or controllers to operate as just described. In other alternate embodiments, the processing circuit 50 may be implemented purely in the form of one or more conventional hardware circuits designed to operate as described above, or as a combination of one or more such hardware circuits and at least one microprocessor or controller operable to execute instructions stored in memory to operate as described above.

The embodiment of the processor 16 depicted by example in FIG. 3 further illustratively includes a second processor 52 operatively coupled to the first processor 50 and also to at least one memory unit 54. In some embodiments, the processor 52 may include one or more peripheral devices, such as a display monitor, one or more input and/or output devices or the like, although in other embodiments the processor 52 may not include any such peripheral devices. In any case, the processor 52 is illustratively configured, i.e., programmed, to execute at least one process for analyzing ion measurement events. Time-based charge detection data (CDD) in the form of charge magnitude and charge timing data (i.e., detection of the timing of charges induced by ions on the charge detection cylinder) received by the processor 50 via the charge detection signals CDS is illustratively transferred from the processor 50 directly to the processor 52 for processing and analysis upon completion of each ion measurement event.

In some embodiments, the processor 52 is illustratively provided in the form of a high-speed server operable to perform both collection/storage and analysis of such data. In such embodiments, one or more high-speed memory units 54 may be coupled to the processor 52, and is/are operable to store data received and analyzed by the processor 52. In one embodiment, the one or more memory units 54 illustratively include at least one local memory unit for storing data being used or to be used by the processor 52, and at least one permanent storage memory unit for storing data long term. In one such embodiment, the processor 52 is illustratively provided in the form of a Linux® server (e.g., OpenSuse Leap 42.1) with four Intel® Xeon™ processors (e.g., E5-465L v2, 12 core, 2.4 GHZ). In this embodiment, an improvement in the average analysis time of a single ion measurement event file of over 100× is realized as compared with a conventional Windows® PC (e.g., i5-2500K, 4 cores, 3.3 GHZ). Likewise, the processor 52 of this embodiment together with high speed/high performance memory unit(s) 54 illustratively provide for an improvement of over 100× in data storage speed. Those skilled in the art will recognize one or more other high-speed data processing and analysis systems that may be implemented as the processor 52, and it will be understood that any such one or more other high-speed data processing and analysis systems are intended to fall within the scope of this disclosure. In alternate embodiments, the processor 52 may be provided in the form of one or more conventional microprocessors or controllers and one or more accompanying memory units having instructions stored therein which, when executed by the one or more microprocessors or controllers, cause the one or more microprocessors or controllers to operate as described herein.

In the illustrated embodiment, the memory unit 54 illustratively has instructions stored therein which are executable by the processor 52 to analyze ion measurement event data produced by the ELIT 14 to determine an ion spectral distribution, i.e., ion mass-to-charge ratio (m/z), ion charge magnitude, ion mass, etc., for a sample under analysis. In one embodiment, the processor 52 is operable to receive ion measurement event data from the processor 50 in the form of charge magnitude and charge detection timing information measured during each of multiple “charge detection events” (as this term is defined above) making up the “ion measurement event” (as this term is defined above), and to process such charge detection events making up such an ion measurement event to determine ion charge and mass-to-charge data, and to then determine ion mass data therefrom. A mass spectral distribution for the sample under analysis can be created in this manner from an ion measurement event in which multiple charged particles are trapped in the ELIT 14 as described above. Multiple ion measurement events may also be processed in like manner to create a mass spectral distribution for the sample under analysis.

In some embodiments, the CDMS 10 described above may be managed in real-time directly from and by the processor 52, wherein operating parameters of the CDMS system 10 and of the ELIT 14 in particular may be selected, e.g., in real time or at any time, and output file management and display may be managed. In other embodiments, the processor 16 may include a separate processor 56 coupled to the processor 52 as illustrated by example in FIG. 3. In such embodiments, the processor 56 is illustratively a conventional processor or processing system for which widely known and used graphing utilities and data processing programs are available. In one example embodiment, the processor 56 is implemented in the form of a conventional Windows®-based personal computer (PC) including one or more such graphing utilities and data processing programs installed thereon. Those skilled in the art will recognize other conventional processors or processing systems which may be suitable for used as the processor 56, and it will be understood that any such other conventional processors or processing systems are intended to fall within the scope of this disclosure. In any case, in embodiments which include the processor 56, a graphical user interface (GUI), e.g., an RTA GUI, may be included to provide a user-friendly and real-time control GUI which is accessible via the processor 56. In one embodiment, the real-time control GUI is stored in the memory 54 and executed by the processor 52, and the processor 56 is used to access the user GUI from the processor 52, e.g., via a secure shell connection between the two processors 52, 56. In alternate embodiments, the real-time control GUI may be stored on and executed by the processor 56. In either case, the processor 56 illustratively acts as a virtual control and visualization unit with which a user may visualize and control one or more aspects of the real time analysis process and of the real-time operation of the CDMS 10 via the real-time control GUI. Whether used to control real-time operation of the CDMS or not, the processor 56 may illustratively be used to visualize output data and spectral distribution information produced by the CDMS instrument 10.

As briefly described above, the voltage sources V1, V2 are illustratively controlled by the processor 16, e.g., via the processor 50, in a manner which selectively establishes ion transmission and ion reflection electric fields (T, R respectively) in the region R1 of the ion mirror M1 and in the region R2 of the ion mirror M2 to guide charged particles into the ELIT 14 from the charged particle source 12, and to then cause multiple charged particles to be selectively trapped and confined within the ELIT 14 such that the multiple trapped charged particles repeatedly pass through the charge detection cylinder CD as they oscillates back and forth between M1 and M2. Referring to FIGS. 4A-4C, simplified diagrams of the ELIT 14 of FIG. 1 are shown depicting an example of such sequential control and operation of the ion mirrors M1, M2 of the ELIT 14. In the following example, the processor 50 will be described as controlling the operation of the voltage sources V1, V2 in accordance with its programming, although it will be understood that the operation of the voltage source V1 and/or the operation of the voltage source V2 may be alternatively controlled, at least in part, by the processor 52.

As illustrated in FIG. 4A, the ELIT control sequence begins with the processor 50 controlling the voltage source V1 to control the ion mirror M1 to the ion transmission mode of operation (T) by establishing an ion transmission field within the region R1 of the ion mirror M1, and also controlling the voltage source V2 to control the ion mirror M2 to the ion transmission mode of operation (T) by likewise establishing an ion transmission field within the region R2 of the ion mirror M2. As a result, charged particles generated by the charged particle source 12 pass into the ion mirror M1 and are focused by the ion transmission field established in the region R1 toward the central, longitudinal axis 20 (see FIG. 1) as they pass into the charge detection cylinder CD. The charged particles then pass through the charge detection cylinder CD and into the ion mirror M2 where the ion transmission field established within the region R2 of M2 focusses the charged particles toward the longitudinal axis 20 such that the charged particles pass through M2 as illustrated by the ion trajectory 60 depicted in FIG. 4A.

Referring now to FIG. 4B, after both of the ion mirrors M1, M2 have been operating in the ion transmission operating mode for a selected time period and/or until successful ion transmission therethrough has been achieved (e.g., by monitoring the charge detection signal CDS to determine the presence of charged particles passing through the charge detection cylinder CD), the processor 50 is illustratively operable to control the voltage source V2 to control the ion mirror M2 to the ion reflection mode (R) of operation by establishing an ion reflection field within the region R2 of the ion mirror M2, while maintaining the ion mirror M1 in the ion transmission mode (T) of operation as shown. As a result, charged particles generated by the charged particle source 12 enter into the ion mirror M1 and are focused by the ion transmission field T established in the region R1 toward the central, longitudinal axis 20 such that the charged particles pass through the ion mirror M1 and into the charge detection cylinder CD as just described with respect to FIG. 4A. The charged particles then pass through the charge detection cylinder CD and into the ion mirror M2 where the ion reflection field R established within the region R2 of M2 reflects the charged particles to cause them to reverse travel so as to travel in the opposite direction and back into the charge detection cylinder CD, as illustrated by the ion trajectory 62 in FIG. 4B.

Referring now to FIG. 4C, after the ion reflection electric field has been established in the region R2 of the ion mirror M2, the processor 50 is operable to control the voltage source V1 to control the ion mirror M1 to the ion reflection mode (R) of operation by establishing an ion reflection field within the region R1 of the ion mirror M1, while maintaining the ion mirror M2 in the ion reflection mode (R) of operation in order to trap the multiple charged particles within the ELIT 14. Between the time that the ion reflection electric field (R) is established within the region R1 of the ion mirror M1 and the ion reflection electric field (R) is established within the region R1 of the ion mirror M2, multiple charged particles enter, and are trapped within, the ELIT 14. With both of the ion mirrors M1, M2 controlled to the ion reflection operating mode (R), the multiple trapped charged particles are caused by the opposing ion reflection fields established in the regions R1 and R2 of the ion mirrors M1 and M2 respectively to oscillate back and forth between the ion mirrors M1 and M2, each time passing through the charge detection cylinder CD as illustrated by the ion trajectory 64 depicted in FIG. 4C and as described above. In one embodiment, the processor 50 is operable to maintain the operating state illustrated in FIG. 4C until the multiple trapped charged particles pass through the charge detection cylinder CD a selected number of times. In an alternate embodiment, the processor 50 is operable to maintain the operating state illustrated in FIG. 4C for a selected time period after trapping the multiple ions in the ELIT 14.

In either embodiment, the number of cycles or time spent in the state illustrated in FIG. 4C may illustratively be programmed, e.g., via instructions stored in the memory 18, or controlled via a user interface, and in any case the ion detection event information resulting from each pass by each of the multiple trapped ions through the charge detection cylinder CD, i.e., in the form of time-based charge detection data (CDD) as described above, is temporarily stored in the processor 50, e.g., in the form of an ion measurement file. When the multiple trapped charged particles have passed through the charge detection cylinder CD a selected number of times or have oscillated back-and-forth between the ion mirrors M1, M2 for a selected period of time, the total number of charged particle detection events stored in the processor 50 represents the charged detection data (CDD), as described above, for a charged particle measurement event (i.e., for an “ion trapping event”) for the multiple trapped charged particles and, upon completion of the charged particle measurement event, the charged particle detection data (CDD) for the charged particle measurement event is stored in a charge detection file (CDF) which is then passed to, or retrieved by, the processor 52. The sequence illustrated in FIGS. 4A-4C then returns to that illustrated in FIG. 4A where the voltage sources V1, V2 are controlled as described above to control the ion mirrors M1, M2 respectively to the ion transmission mode (T) of operation by establishing ion transmission fields within the regions R1, R2 of the ion mirrors M1, M2 respectively. The illustrated sequence then repeats for as many times as desired.

The time-based charge detection data (CDD) in a charge detection file (CDF) is illustratively analyzed in the frequency domain using a series of short-time overlapping Fast Fourier Transform (FFT) algorithms stepped sequentially through the CDD, as will be described in greater detail below with respect to FIGS. 5-7. In such implementations, oscillation frequency and charge magnitude pairs are determined for each of the multiple charged particles trapped in the ELIT 14 based on the fundamental frequencies (f0) of the series of time overlapping FFTs, wherein the oscillation frequency and charge magnitude of each of the multiple charged particles corresponds to the frequency and magnitude respectively of the fundamental frequency f0 of that charged particle averaged across the series of short-time overlapping FFTs, as described further below. Ultimately, i.e., following processing of the CDD for one or multiple ion trapping events, mass-to-charge ratios (m/z) of the charged particles are determined based on the fundamental frequency f0 and a calibration constant (C) according to Equation 1 below, and the masses of the charged particles are then determined as products of the respective m/z and charge magnitude of each of the charged particles.

$$\frac{m}{z} = \frac{C}{{f}_{0}^{2}} \qquad Equation 1$$

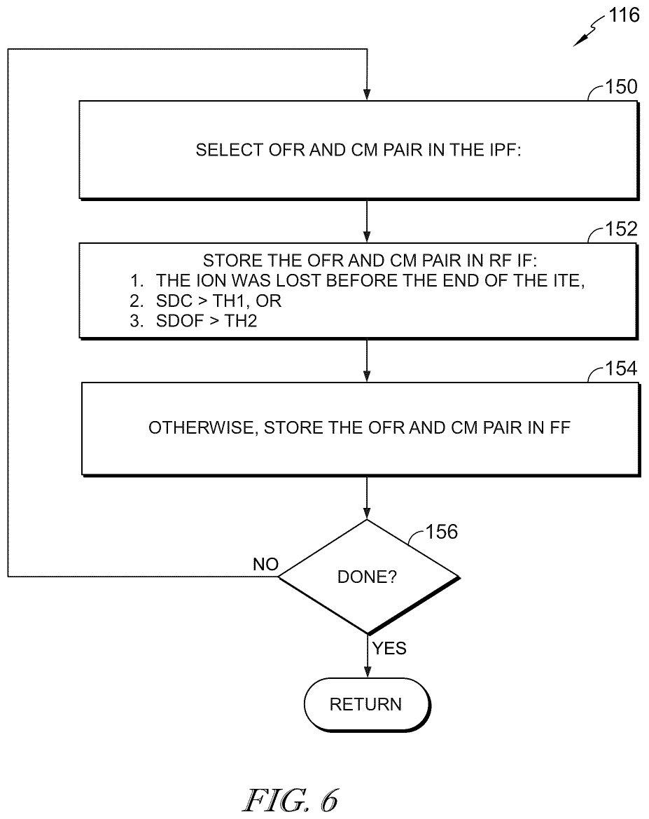

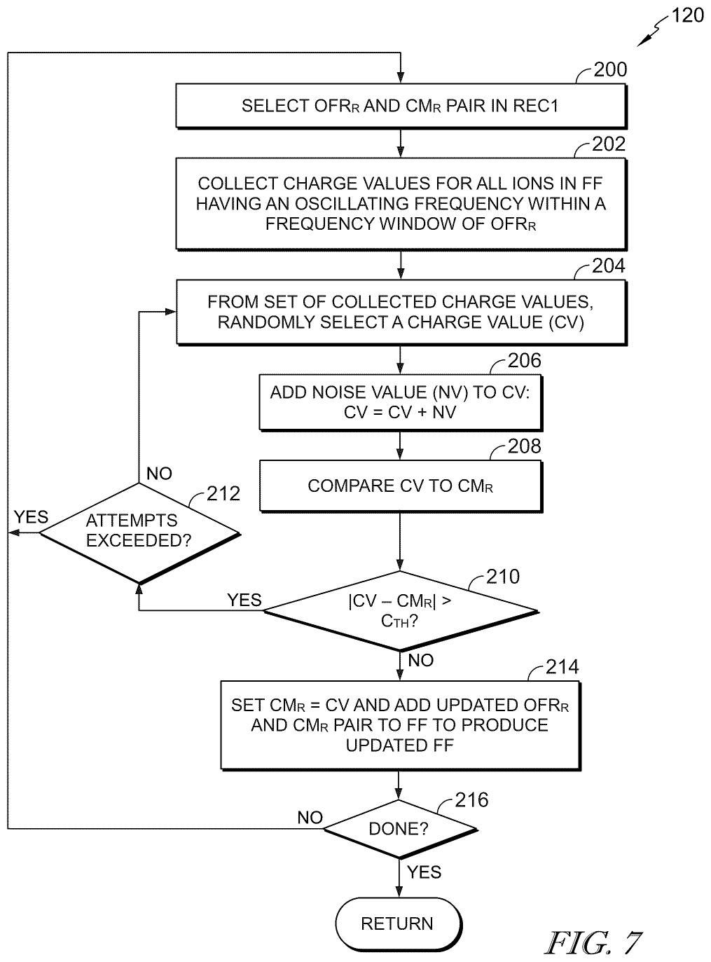

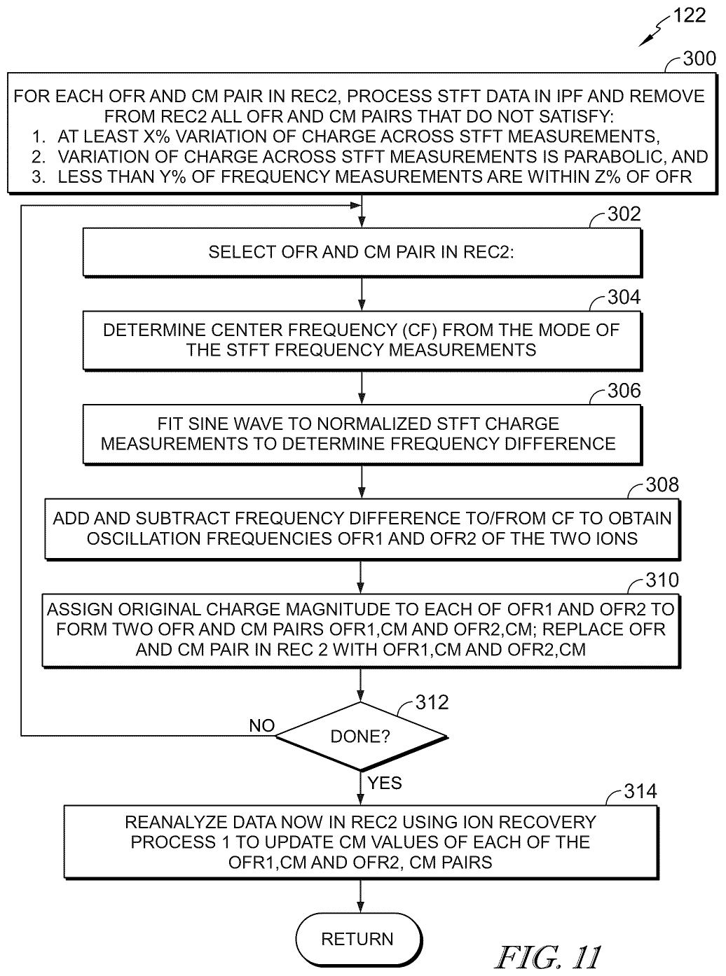

Referring now to FIG. 5, a flowchart is shown of a process 100 for processing the time-based charge detection data (CDD) resulting from measurements by the charge-sensitive preamplifier, CP, of charges induced on the charge detection cylinder, CD, by the multiple trapped charged particles passing therethrough as they oscillate back and forth between the ion mirrors M1, M2 during one or more trapping events as described above, and for ultimately determining mass-to-charge ratios and charge magnitudes of such charged particles. The process 100 further illustratively includes at least one process for recovering charged particle data that has been rejected (i.e., omitted from the analysis results) due to measurement inaccuracies associated with charged particles having overlapping oscillation frequencies. Resulting from one or more iterations of the process 100 (including the embedded processes illustrated by example in FIG. 6 and the embedded process(es) illustrated by example in either or both of FIGS. 7 and 11), is a charged particle spectral distribution, including one or a combination of mass-to-charge ratio (m/z), mass (m), and charge magnitude (z), for each of the multiple trapped charged particles of the one or more trapping events. The process 100 is illustratively stored and executed in and by the processor 50 described above, stored in the memory 54 and executed by the processor 52, stored and executed in and by the processor 56, stored, in part, in the processor 50 and, in part, in the memory 54, and executed, in part, by the processor 50 and, in part, by the processor 52, or stored, in part, in the processor 56 and, in part, in the memory 54, and executed, in part, by the processor 56 and, in part, by the processor 52. In this regard, the phrase “50, 52 and/or 56” means one or any sub-combination or combination of the processors 50, 52, 56. In any case, the process 100 begins at step 102 where the time-based charge detection data (CDD) for an ion trapping event (ITE) (alternatively, an “ion measurement event” as described above) is collected and stored in a charge detection file (CDF), as described above in the example depicted in FIGS. 4A-4C. In one embodiment, charge detection data, CDD, for a first time window of the ITE is discarded, and CDD for a remaining time duration is collected and stored in the CDF. In one non-limiting example of such an embodiment, CDD for the first 2 milliseconds (ms) of the ITE is discarded, and the next 104.8 ms (corresponding to 218 points) is collected and stored in the CDF. In alternate embodiments more or less (or none) of the initial or front-end CDD may be discarded, and the ITE may last for any desired duration so as to collect any number of data points over the ITE duration.

Following step 102, the process 100 advances to step 104 where the processor 50, 52 and/or 56 is operable to compute a “full event” Fourier transform (FEFT) of all the charge detection data in the CDF. In one embodiment, the processor 50, 52 and/or 56 is operable to compute FEFT using a conventional fast Fourier transform (FFT) technique, although in alternate embodiments the processor 50, 52 and/or 56 may alternative or additionally use any conventional Fourier transform technique. Following step 104, the processor 50, 52 and/or 56 is operable at step 106 to determine whether, based on the FEFT, no ions were captured in the ELIT 14 during the ITE, i.e., whether the ion trapping event failed to trap any charged particles in the ELIT 14. For example, if the FEFT at step 104 failed to produce any frequency peaks, captured only noise peaks, or the like, such that no valid oscillating frequency and charge magnitude pairs could be determined from the FEFT, the processor 50, 52 and/or 56 makes the determination no charged particles were trapped in the ELIT 14 during the ion trapping event (ITE). If so, the process advances to step 108 where the processor 50, 52 and/or 56 is operable to discard the charge detection data (CDD) in the charge detection file (CDF), and the process 100 loops back to step 102. In some alternate embodiments, step 108 may execute a process in which the processor 50, 52 and/or 56 is operable to analyze the CDD in the CDF and/or the FEFT (before discarding the CDD) in further detail to determine whether the charge detection data (CDD) does in fact include some discernible charged particle measurement information. If, resulting from such analysis, the CDD does include discernible charged particle measurement information, the corresponding FEFT is passed to step 110 for further processing as indicated by the dashed-lined arrow extending between steps 108 and 110, and otherwise the process 100 loops back to step 102 as described above. A non-limiting example of such a further detailed process for analyzing the CDD in the CDF and/or the FEFT at step 108 is disclosed in WO 2019/236140, the disclosure of which is expressly incorporated herein in its entirety.

In any case, following step 108 or following the “NO” branch of step 106, the processor 50, 52 and/or 56 is operable at step 110 to analyze the FEFT to determine and identify in a conventional manner, e.g., from the frequency peaks in the FEFT, each of the multiple ions trapped (and measured) in the ELIT 14 during the ITE. Thereafter at step 112, the processor 50, 52 and/or 56 is operable to compute a series of short-time overlapping Fourier transforms (STFT), e.g., using an FFT or other conventional Fourier transform determination technique, stepped sequentially through the charge detection data (CDD) in the charge detection file (CDF), i.e., stepped sequentially through CDD as a function of time. The number and size (i.e., width) of the STFT's may vary, and may depend on one or more factors, examples of which may be or include, but which are not limited to, the size (i.e., time duration) of the CDF file, the size (i.e., amplitude(s)) of the time-based CDD signal, the number of trapped charged particles determined at step 110, or the like. In some embodiments, the STFT's are zero-padded to produce files sizes equivalent to that of the CDD and FEFT.

Following step 112, the process 100 advances to step 114 where the processor 50, 52 and/or 56 is operable to process the STFT's to track each of the multiple, trapped charged particles across the ion trapping event and determine an oscillating frequency (OFR) and a charge magnitude (CM) for each of the multiple, trapped charged particles. For example, for each of the multiple, trapped charged particles, at least some of the STFT's across the ITE will include a frequency peak at the fundamental frequency f0 of that charged particle within the ELIT 14. For each such multiple, trapped charged particle, the processor 50, 52 and/or 56 is illustratively operable at step 114 to determine the oscillating frequency (OFR) of the charged particle as an average of the fundamental frequencies f0 of that charged particle over all of the STFT's which include f0 of that charged particle, and to determine the charge magnitude (CM) as an average of the peak magnitudes of all such fundamental frequencies f0. The processor 50, 52 and/or 56 is further illustratively operable at step 114 to compute, for each of the multiple, charged particles, a standard deviation of the oscillating frequency (SDOF) and a standard deviation of the charge magnitude (SDC) relative to all of the fundamental frequency and peak magnitude values used to compute the respective averages. Resulting from step 114 is thus an oscillating frequency (OFR) and charge magnitude (CM) pair, as well as standard deviations (SDOF) and (SDC) for each of the multiple, trapped charged particles. It will be understood that in alternate embodiments, the analysis and/or computations made at steps 110-114 may alternatively be made using other frequency-domain analysis techniques, and that in still other embodiments such analysis and/or computations may be made using time-domain analysis techniques. In any case, the result of step 114 will be to produce OFR, CM, SDOF, and SDC for each of the multiple, trapped charged particles, and at step 114 the OFR, CM, SDOF, and SDC values for each such charged particle is illustratively stored by the processor 50, 52 and/or 56 at step 114 in an ion processing file (IPF).

Following step 114, the process 100 advances to step 116 where the processor 50, 52 and/or 56 is operable to conduct a quality check of the values of the oscillation frequency and charge magnitude pairs, OFR, and CM, stored in the ion processing file IPF. OFR and CM pairs found to be acceptable according to the quality check are illustratively stored in a filtered file FF, whereas OFR and CM pairs found to be unacceptable according to the quality check are illustratively stored in a rejected file RF. In some embodiments, the standard deviation values SDOF and SDC associated with each OFR and CM pair are also stored in the respective filtered file FF or rejected file RF.

One example implementation of the quality check conducted at step 116 is illustrated by example in FIG. 6 which depicts a flowchart of the quality check example. In the illustrated embodiment, the quality check 116 illustratively begins at step 150 where the processor 50, 52 and/or 56 selects one of the OFR and CM pairs stored in the ion processing file IPF. Thereafter at step 152, the processor 50, 52 and/or 56 is operable to store the selected OFR and CM pair in the rejected file RF if: (1) the ion was lost before the end of the ion trapping event, (2) SDC (associated with the selected OFR and CM pair) is greater than a threshold standard deviation value TH1, or SDOF (also associated with the selected OFR and CM pair) is greater than another threshold standard deviation value TH2. Filtering condition (1) is illustratively conducted for each of the charged particles identified at step 110 by tracking the respective charged particle across the series of short-time overlapping FFT's, and determining whether frequency data for that charged particle is present for the full ITE. In one embodiment, a “full’ trapping event is illustratively defined as one in which a charged particle is trapped within the ELIT 14 for at least a set amount of the total trapping time of the trapping event ITE, e.g., for at least 90% of the total trapping time of the trapping event ITE. In other embodiments, the set amount of time may be greater or less than % 90 of the ITE, and in still other embodiments the set amount of time may be % 100 of the ITE; i.e., a “full” trapping event corresponds to the entire ITE. Illustratively, the filtering condition (1) analysis may be carried out by the processor 50, 52 and/or 56 at step 152 by analyzing the STFT data as just described for the selected OFR and CM pair. Alternatively, the filtering condition (1) analysis may be conducted by the processor 50, 52 and/or 56 during the STFT processing step step 114 of the process 100 of FIG. 5. In some such embodiments, the processor 50, 52 and/or 56 may be operable to set a status indicator, e.g., a flag or other indicator, having some type of pass/fail value such that the flag or other indicator is set to “pass” (or other value) if the STFT data for charged particle in question is present for the entire ITE, and to otherwise set the flag or other indicator to “fail” (or other value). At step 152 of the quality check 116 of FIG. 6, the filtering condition (1) analysis may then be carried out simply by checking the status of the flag or other indicator associated with the selected OFR, CM pair.

With respect to filtering condition (2), trapped charged particles having similar oscillation frequencies may have overlapping f0 values in the frequency domain, and the amount or degree of frequency overlap will affect the charge magnitude standard deviation values SDC. Because the charge magnitude of an individual charged particle in the set of trapped charged particles is determined in the frequency domain as the average magnitude of the peak of the corresponding fundamental frequency values f0 of the series of STFTs, such charge magnitude determinations become less reliable as the overlap between oscillation frequencies of trapped charged particles increases due to frequency peak crowding. And the greater the amount or degree of frequency overlap, for example, the greater will be the value of the corresponding SDC. In this regard, charged particles having a charge magnitude standard deviation SDC that is greater than a threshold standard deviation value, TH1, are deemed by the processor 50, 52 and/or 56 at step 156 to have imprecisely determinable charge magnitude values, and the OFR, CM pairs of such charged particles are therefore deemed to be unacceptable. Selection of the threshold value, TH1, will generally depend on a number of factors including the desired accuracy of the charge magnitude values and/or other considerations.

With respect to filtering condition (3), trapped charged particles that have more stable traversal paths within the ELIT 14 will generally have lower standard deviations in their respective f0 (or OFR) than those with less stable traversal paths. In the ELIT 14, for example, highly stable charged particles will generally oscillate back and forth between the ion mirrors M1, M2 with a substantially constant oscillation frequency, whereas less stable and unstable charged particles may deviate from an otherwise constant oscillation frequency by deviating in the ion mirror M1, the ion mirror M2 and/or in the charge detection cylinder, CD, from a flight path that is on or near the longitudinal axis 20. In this regard, charged particles having a standard deviation SDOF that is greater than a threshold standard deviation value, TH2, are deemed by the processor 50, 52 and/or 56 at step 152 to be unstable and therefore unacceptable. Selection of the threshold value, TH2, will generally depend on a number of factors relating to the particular structure and operation of the ELIT 14, and will typically be determined empirically.

In any case, OFR, CM pairs lost before the end of the ITE, that have charge magnitude standard deviations SDC greater than TH1, or that have oscillating frequency standard deviations SDO greater than TH2 are stored by the processor 50, 52 and/or 56 in the rejected file RF at step 152, and all other OFR, CM pairs are stored by the processor 50, 52 and/or 56 in the filtered file FF at step 154. Following step 154, the processor 50, 52 and/or 56 is operable at step 156 to loop back to step 150 until all of the OFR, CM pairs in the ion processing file IPF are processed. The quality check process 116 then returns to the process 100 of FIG. 5.

When trapping and simultaneously measuring charge detection information for multiple charged particles in the CDMS 10 as described above, the OFR, CM pairs contained with the filtered file FF following execution of step 116 are those which are conventionally used by the processor 50, 52 and/or 56, e.g., for 1 or more iterations of the process 100, to compute and represent the charged particle spectral distribution, i.e., ion mass-to-charge ratio (m/z), ion charge magnitude, ion mass, etc., at step 124 for the sample under analysis. In the embodiment of the process 100 illustrated in FIG. 5, however, additional steps 118-122 are illustratively included following step 116, wherein the processor 50, 52 and/or 56 is operable to execute either one or both of two different charged particle recovery processes in which certain OFR, CM pairs in the rejected file RF are processed and modified as described below, and then added to the filtered file FF to provide for a more complete and accurate representation of the charged particle spectral distribution for the sample under analysis. In particular, each of the charged particle recovery processes operates OFR, CM pairs rejected at step 152 as a result of filtering condition (2). Recovery of any such previously rejected charged particles will result in a more accurate ion spectral distribution, particularly for charged particles having similar oscillation frequencies and attendant frequency overlap in the frequency domain.

Referring now to the charged particle recovery steps 118-120 of the process 100 illustrated in FIG. 5, step 118 is a preparation step in which OFR and CM pairs in the rejected file RF which meet certain criteria are selected for further processing by either or both of two different charged particle recovery processes. Some embodiments of the process 100, for example, may include only the charged particle recovery process 1 of step 120, and in such embodiments the preparation step 118 illustratively includes only the portion of step 118 which populates a charged particle recovery file REC1 from the rejected file RF which was populated at step 116. Alternate embodiments of the process 100 may, as another example, include only the charged particle recovery process 2 of step 122, and in such embodiments the preparation step 118 illustratively includes only the portion of step 118 which populates a charged particle recovery file REC2 from the rejected file RF. Still other embodiments of the process 100 may include both of the charged particle recovery process 1 of step 120 and the charged particle recovery process 2 of step 122, and in such embodiments the preparation step 118 illustratively populates both REC1 and REC2 from the rejected file RF. One illustrative embodiment of the charged particle recovery process 1 is illustrated in the form of a flowchart depicted by example in FIG. 7, and one illustrative embodiment of the charged particle recovery process 2 is also illustrated in the form of a flowchart depicted by example in FIG. 11, both examples of which will be described in detail below.

As briefly described above, the charged particle recovery process 1 and the charged particle recovery process 2 operate on OFR, CM pairs that are in the rejected file RF as a result of filtering condition (2); namely, SDC>TH1, corresponding to trapped charged particles having similar oscillation frequencies that may have overlapping f0 values in the frequency domain, i.e., that have overlapping oscillation frequencies. In embodiments of the process 100 which include step 120, the processor 50, 52 and/or 56 is illustratively operable at step 118 to store in REC1 each OFR and CM pair in the rejected file RF which satisfies (1) ion trapped for the full ITE, (2) SDC>TH1, (3) SDOF<TH2, and (4) F1<OFR<F2. Conditions (1) and (3) are illustratively the opposite of conditions (1) and (3) respectively of step 152 of step 116 described above, and condition (2) is the same as condition (2) of step 116. Condition (1) of step 118 illustratively ensures that the data in the recovery file REC1 includes OFR, CM pairs only for those charged particles that were not lost during the ion trapping event (ITE), i.e., charged particles that were trapped in the ELIT 14 for the “full” trapping event. Condition (3) of step 118 illustratively ensures that the data in the recovery file REC includes OFR, CM pairs only for stable charged particles, i.e., those having frequency standard deviations SDOF less than TH2, wherein TH2 illustratively has the same value as that used in step 152 of the process 116.

Condition (4) of step 118 illustratively provides for the selection of a frequency window within which to include OFR, CM pairs in the recovery file REC1 that have oscillation frequencies, OFR, which overlap with the oscillation frequencies, OFR, of other charged particles in the recovery file REC1. In this regard, F2 illustratively represents an oscillation frequency at, and below, which oscillation frequency overlap between charged particles begins to occur. In one example implementation, which should not be considered to be limiting in any way, F2 may be about 50 Hz, although it will be understood that in other implementations F2 may be greater or less than 50 Hz. F1, on the other hand, illustratively represents an oscillation frequency at, and below, which oscillation frequencies of two charged particles overlap but for which the oscillation frequencies of the two overlapping charged particles are indiscernible from one another, i.e., the oscillation frequencies are unresolvable relative to one another. In one example implementation, which should not be considered to be limiting in any way, F1 may be about 10 Hz, although it will be understood that in other implementations F1 may be greater or less than 10 Hz In one embodiment, the processor 50, 52 and/or 56 may be operable at step 118 to include in REC1 each OFR, CM pair that has SDC>TH1 (as well as conditions (1) and (3)) and OFR within 50 Hz or less (F2) of another OFR, CM pair having an OFR value that is discernible from that of the first OFR, CM pair, and to exclude from REC1 each OFR, CM pair that has SDC>TH1 (as well as conditions (1) and (3) and OFR that is not within 50 Hz or less (F2) of another OFR, CM pair having an OFR value that is discernible from that of the first OFR, CM pair (F1).

In embodiments of the process 100 which include step 122, the processor 50, 52 and/or 56 is operable at step 118 to store in REC2 each OFR, CM pair in the rejected file RF that also meet conditions (1)-(3) of step 118 but which have OFR values less than F1. In one embodiment, the processor 50, 52 and/or 56 may be operable at step 118 to include in REC2 each OFR, CM pair that has SDC>TH1 (as well as conditions (1) and (3)) and OFR that is not within 50 Hz or less (F2) of another OFR, CM pair having an OFR value that is discernible from that of the first OFR, CM pair (F1), as described above. It will be understood that other processing techniques may alternatively be used by the processor 50, 52 and/or 56 at step 118 to populate REC1 and/or REC2. In any case, any process for populating REC1 from the rejected file RF will store in REC1 OFR, CM pairs in RF that meet conditions (1) and (3) of step 118, that have oscillation frequencies which overlap with oscillation frequencies of other OFR, CM pairs, and for which the overlapping oscillation frequencies are discernible from one another. Any process for populating REC2 from the rejected file RF will store in REC2 OFR, CM pairs in RF that meet conditions (1) and (3) of step 118, that have oscillation frequencies which overlap with oscillation frequencies of other OFR, CM pairs, but for which the overlapping oscillation frequencies are indiscernible from one another.

Following the first execution of step 122, in embodiments which include it, or from the first execution step 120 in embodiments which do not include step 122, the filtered file FF is populated with OFR, CM values for one ion trapping event (ITE). In some embodiments, the process 100 proceeds from this point directly to step 124. In other embodiments, the process 100 loops back to step 102 to process another ion trapping event (ITE). In this manner, the filtered file FF may illustratively be populated with OFR, CM values for one or any number of ion trapping events (ITE) before proceeding to step 124. In any case, upon advancement of the process 100 to step 124, the processor 50, 52 and/or 56 is illustratively operable to determine and produce a spectral distribution from the OFR, CM pairs in the most recently updated filtered file FF. As described above, the OFR values of the OFR, CM pairs may be converted to charged particle mass-to-charge values (m/z) using equation 1 above (wherein f0=OFR). Alternatively or additionally, charged particle mass values (m) may be computed using the m/z values and corresponding charge magnitude values, CM.

Referring now to FIG. 7, a flowchart is shown of an example embodiment of the ion recovery process 1 of step 120 of the process 100 of FIG. 5. The ion recovery process 120 depicted by example in FIG. 7 is, like the process 100 depicted in FIG. 5, illustratively executable by the processor 50, 52 and/or 56. The charged particle recovery process 120 illustrated in FIG. 7 begins at step 200 where the processor 50, 52 and/or 56 is operable to select an OFR, CM pair in the charged particle recovery file REC1 (OFR_{R} and CM_{R}, respectively). Thereafter at step 202, the processor 50, 52 and/or 56 is operable to collect charge values, i.e., charge magnitude values CM, for all of the OFR, CM pairs in the filtered file FF that have an oscillation frequency OFR that is within a frequency window, e.g., F_{W}, of the oscillation frequency OFR_{R} of the OFR_{R}, CM_{R} pair selected at step 200. In one embodiment, the frequency window, F_{W}, is illustratively the same oscillation frequency at which oscillating frequency overlap of charged particles begins to occur and below which such oscillating frequency overlap does occur, e.g., 50 Hz, although in alternate embodiments F_{W} may have a higher or lower value.

In any case, the process 120 advances from step 202 to 204 where the processor 50, 52 and/or 56 is operable to randomly select a charge value CV from the charge magnitudes CM of the set of charge magnitude values collected at step 202. Thereafter at step 206, the processor 50, 52 and/or 56 is operable to modify the selected charge value CV so as to account for fluctuations due to electrical noise. In the illustrated embodiment, for example, the processor 50, 52 and/or 56 is operable at step 206 to account for such fluctuations by adding a noise value, NV, to the selected charge value, CV; i.e., CV=CV+NV. In one embodiment, NV is determined by the processor 50, 52 and/or 56 from a Gaussian distribution with a standard deviation corresponding to the standard deviation of the charge value CV selected at step 204. Illustratively, the noise value NV is a fraction, and in some embodiments a small fraction, of the elementary charge e. In alternate embodiments, the processor 50, 52 and/or 56 may be operable at step 206 to compute the noise value NV in accordance with other conventional noise analysis techniques, and/or to modify the selected charge value CV using one or more other or additional mathematical operators, equations, or models. In any case, the process 120 advances from step 206 to step 208.

At steps 208 and 210, the processor 50, 52 and/or 56 is illustratively operable to perform a check or analysis to ensure that the modified charge value CV determined at step 206 is reasonable. For example, in the OFR, CM data stored in the filtered file FF, there may be different subpopulations of charged particles with similar or identical oscillation frequency values OFR, but with different charge magnitude CM populations, and at step 208 and 210 the processor 50, 52 and/or 56 illustratively assesses the reasonableness of the modified (at step 206) charge magnitude value CV relative to the charge magnitude CM_{R} of the OFR_{R}, CM_{R} pair selected at step 200. In the illustrated embodiment, for example, the processor 50, 52 and/or 56 is operable at step 208 to compare the modified (at step 206) CV to CM_{R}, and thereafter at step 210 to accept the modified CV as reasonable if the difference between CV and CM_{R} does not exceed a charge threshold value C_{TH}. Illustratively, C_{TH} is selected such that the modified charge value CV must be substantially different from the charge value CM_{R} in order to satisfy the inequality and advance from the YES branch of step 210 to step 212. In one example implementation, which should not be considered to be limiting in any way, C_{TH} is selected to be twice the standard deviation (SDC_{R}) of CM_{R}, i.e., C_{TH}=+/−(2*SDC_{R}), although it will be understood that in alternate implementations C_{TH} may be greater or lesser than twice the standard deviation SDC_{R} of CM_{R}, and/or in the value of C_{TH}, the “+/−” may be replaced with a “+” only or a “−” only.

From the YES branch of step 210, the process 120 advances to step 212 where the processor 50, 52 and/or 56 is operable to determine whether the maximum number of attempts to assign a modified charge value CV to the OFR_{R}, CM_{R} pair selected at step 200 is exceeded. If not, the process 120 loops back to step 204 where the processor 50, 52 and/or 56 is operable to randomly select another charge magnitude value CV from the set of charge magnitude values collected at step 202. Illustratively, the maximum number of attempts to assign a charge value to the rejected charged particle will depend on the application, and may depend on a number of factors such as, for example, the total number of charge magnitude values collected at step 202, the maximum desired analysis time for each of the OFR, CM pairs in the REC1 file, and the like. In any case, if the processor 50, 52 and/or 56 determines at step 212 that the maximum number of attempts will be exceeded by looping back to step 204, the process 120 loops back to step 200 where the process of assigning a charge magnitude value to the selected OFR_{R}, CM_{R} pair is abandoned and a different OFR_{R}, CM_{R} pair is selected from the recovery file REC1 and processed as just described.

If, at step 210, the difference between the modified charge magnitude value CV and CM_{R} is less than C_{TH}, the process 120 advances to step 214 where the processor 50, 52 and/or 56 is operable to replace CM_{R} of the OFR_{R}, CM_{R} pair selected at step 200 with the modified charge magnitude value CV, and then to add the resulting, updated OFR_{R}, CM_{R} pair (i.e., with CM_{R} updated to the modified charge value CV) to the filtered file FF. Following step 214, the process advances to step 216 where the processor 50, 52 and/or 56 is operable to determine whether all of the OFR_{R}, CM_{R} pairs in REC1 have been processed. If not, the process 120 loops back to step 200. If at step 214 the processor 50, 52 and/or 56 determines that all of the OFR_{R}, CM_{R} pairs in REC1 have been processed, the process 120 returns to the process 100 of FIG. 5.

The updated filtered file FF, resulting from the each execution of the process 120 contains OFR, CM pairs for the originally acceptable charged particles, i.e., those accepted at step and stored in the filtered file FF at step 116 of the process 100 illustrated in FIGS. 5 and 6, as well as originally rejected OFR, CM pairs in REC1 which now have successfully assigned charge values.

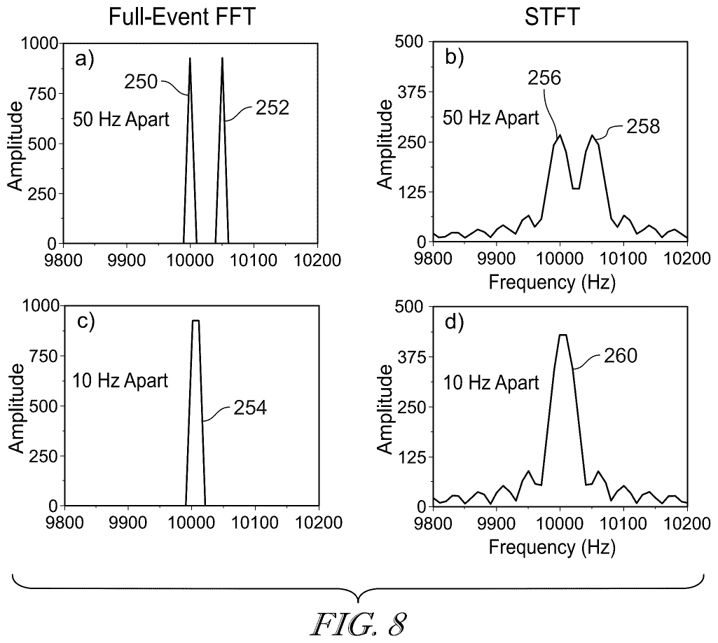

The process 120 just described produces desirable results for ions with overlapping oscillation frequencies in which the oscillation frequencies of each of the overlapping ions can be directly observed, i.e., in which the oscillation frequencies of the overlapping charged particles are discernible from one another, e.g., overlapping oscillation frequencies of approximately >10 Hz. However, for ions with overlapping oscillation frequencies in which the oscillation frequencies of each of the overlapping ions are too close to one another to be directly observed, e.g., overlapping oscillation frequencies of approximately ≤10 Hz, the process 120 cannot recover both OFR and CM of such ions due to the inability to discern the OFR values from one another. This is illustrated by example in FIG. 8 in which a full-event FFT is shown in FIG. 8a) for two ions spaced 50 Hz apart in oscillation frequency so as to produce two clearly resolved peaks 250, 252 centered at approximately 1 kHz and 1.05 kHz, respectively. In FIG. 8b), an STFT of the time domain signal is shown in which the same two ions produce respective peaks 256, 258 also centered at approximately 1 kHz and 1.05 kHz respectively, although they are no longer baseline resolved (demonstrating the onset of oscillation frequency overlap). As the frequency separation of the two ions decreases, the peak overlap becomes more severe until, at some point, only a single peak is observed. This is illustrated by example in FIGS. 8c) and 8d) in which a full-event FFT and corresponding STFT are shown for two ions spaced 10 Hz apart in oscillation frequency. In the FFT of FIG. 8c) and the STFT of FIG. 8d), only a single peak 254, 260 respectively is observed, thus obscuring the fact that two ion peaks are actually present.

Overlapping frequencies occur more often for abundant features in the mass distribution, so discarding from the spectral distribution ions with overlapping frequencies leads to a distortion of the relative abundances. The ion recovery process 1, illustrated by example at step 120 of FIG. 5 and also by the process 120 illustrated by example in FIG. 7, rescues some such discarded ions by using a statistical approach to reassign their charges which, in turn, alleviates some of the distortion in the relative abundances. However, as the frequency difference between two neighboring ions decreases to and below a point where the oscillation frequencies of the two ions cannot be discriminated from one another, e.g., ≤10 Hz, neither the full event FFT nor the STFTs are able to differentiate the oscillation frequencies of the two ions as illustrated by example with the ion frequency peaks 254 and 260 in FIGS. 8c) and 8d). Between the frequency differences of FIGS. 8a) and 8c), the frequency peaks 250, 252 respectively of the two ions have begun coalescing, and as the difference between the frequency peaks decreases, e.g., to and below 10 Hz, the center frequency shifts to a value resembling the mean of the two as depicted by example with the single frequency peak 254 in the FFT of FIG. 8c). If an STFT is taken of this data, the peak begins to broaden, as depicted by example with the peak 260 in FIG. 8d). Therefore, it is not possible to determine with confidence from this data whether two ions were indeed trapped with very similar frequencies. In such cases, the process 120 illustrated by example in FIG. 7 may recover only a single ion, so the total number of ions will still be depleted. However, as described in detail below, an analysis of beat patterns that result from two ions with similar oscillating frequencies moving in and out of phase with one another can be employed to identify situations where such ions produce two unresolved peaks, and a process employing such a beat pattern analysis may then be developed to recover otherwise indiscernible charged particles with overlapping peak frequencies of, e.g., ≤10 Hz.

Referring now to FIGS. 9a) and 9b), two simulated ion signals 270 and 272 respectively with slightly different frequencies start 180° out of phase relative to one another. In the illustrated example, the frequency of the ion signal 270 is 1 kHz, and the frequency of the ion signal 272 is 1.01 kHz, i.e., a 10 Hz difference therebetween. FIG. 9c) shows a signal pattern 274 which represents the two signals 270, 272 overlaid on one another, and FIG. 9d) shows the two overlaid signals 270, 272 summed together to form a composite signal 276. If it is assumed that both ions carry the same charge (equal to 1 charge unit), the detected signals will be 2 when both ions are in the detection cylinder at the same time. When one ion is in and one out, the signal will be 1, and with both ions out the signal will be 0. The signals move in and out of phase relative to one another with a frequency that equals the difference in the frequencies of the two ions. However, real signals have electrical noise which obscures the behavior illustrated in FIG. 9d), and to overcome such noise a series of STFT can be taken, as described above, to reveal the interference between the two signals.

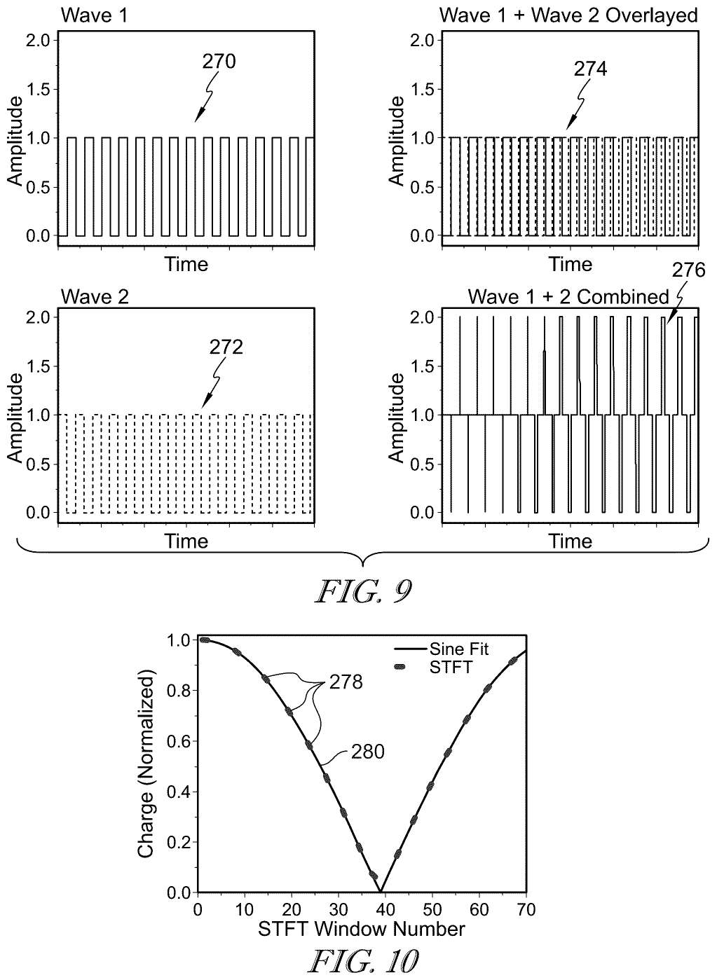

FIG. 10 shows a plot of the magnitude of charge determined as STFT windows are stepped across the time domain data of FIG. 9, as described above. The points 278 are the STFT results as a function of the STFT window number (only a selection of points are shown for clarity), and the line 280 passing through the points 278 represents a fit to the expected behavior, which is the absolute value of a sine function. The variation in the charge shows a beat pattern due to the signals moving in and out of phase with one another. At STFT window number 0, the two signals are perfectly in phase, leading to the maximum charge, while for the minimum (close to the STFT window number 39) the two signals are perfectly out of phase. The fit 280 of the expected behavior (absolute value of a sine function) to the STFT values reveals the frequency difference between the two signals. For the example shown in FIG. 9, the two frequencies are 1000 Hz and 1010 Hz, yielding a beat frequency of 10 Hz. Using this approach, it is possible to identify ions with oscillation frequencies that are sufficiently close so as to be unresolved in the FFT frequency domain, e.g., ≤10 Hz, in order to determine the difference between these frequencies accurately.

A frequency difference of 10 Hz, with the two ions starting in phase at the beginning of a trapping period of 100 ms, will result in the beat pattern 280 shown in FIG. 10. However, with real signals, the two ions do not necessarily start in phase at the beginning of the trapping period. Thus, the beat pattern in FIG. 10 will be offset by an amount that reflects the phase difference at the beginning of the trapping period. Moreover, for frequency differences of less than 10 Hz, only a portion of the beat pattern in FIG. 10 will be apparent during the trapping period. Thus, to identify situations where there are two ions trapped with overlapping frequencies that cannot be resolved in frequency space, it is necessary to identify situations where the STFT charge values follow at least a portion of the beat pattern illustrated in FIG. 10, offset by an arbitrary amount.

Referring now to FIG. 11, a flowchart is shown of an example embodiment of the ion recovery process 2 of step 122 of the process 100 of FIG. 5. The ion recovery process 122 depicted by example in FIG. 11 is, like the process 100 depicted in FIG. 5, illustratively executable by the processor 50, 52 and/or 56. The process 122 illustratively recovers charged particles with overlapping oscillation frequencies using the foregoing beat frequency analysis so as to recover charged particles having oscillation frequencies spaced sufficiently closely together so as prevent direct observation of the oscillation frequencies of each. The resulting filtered file FF will thus include data for charged particles that would otherwise be omitted from the filtered file FF, i.e., without employing the charged particle recovery process 2 of step 122 of the process 100 of FIGS. 5 and 11. The resulting filtered file FF will also include additional data for charged particles that cannot be recovered using the ion recovery 120 of FIG. 7 alone due to the above-noted limitations thereof.

The process 122 illustrated by example in FIG. 11 begins at step 300 where the processor 50, 52 and/or 56 is operable to initially perform a number of tests for each OFR, CM pair stored in the charged particle recovery file REC2 to identify pairs with unresolved frequencies, and OFR, CM pairs that do not pass or otherwise satisfy the tests are removed from REC2. The OFR and CM pairs stored in the charged particle recovery file REC2 are those from the rejected file RF having oscillation frequencies spaced sufficiently closely together so as prevent direct observation of the oscillation frequencies of each, as well as meeting other criteria as described above with respect to step 118 of the process 100 of FIG. 5. In the illustrated embodiment, the tests of step 300 include the following two tests of the charge magnitudes of the STFTs to identify OFR, CM pairs with unresolved oscillation frequencies: 1) there should be at least a X % variation in the STFT charge magnitude values as the STFT window is swept through the time domain data; and 2) the variation in the STFT charge magnitude values across the ion trapping event should show parabolic (i.e., non-linear) behavior. Tests 1) and 2) may illustratively be performed at step 300 by reanalyzing the STFT data from step 112, or may instead be performed during the STFT processing step of step 114 and recalled from memory at step 300. In one embodiment, X is illustratively 90, although in alternate embodiments X may be greater or less than 90.

In any case, for any OFR, CM pair in REC2 that passes both 1) and 2), the following third test (3) is performed by the processor 50, 52 and/or 56 on the frequencies of the STFTs: if greater than Y % of the frequencies are within Z % (or within Z Hz) of OFR, the OFR, CM pair is treated as resulting from a single ion. This is primarily the case if two ions have a frequency difference less than a 1 Hz, or if more than two ions are present in the same small frequency range (illustratively, only two ions with similar frequencies are considered in the process 122 illustrated in FIG. 11). In one embodiment, Y is 90, and Z is 0.75 Hz, although it will be understood that in alternate embodiments other values may be used for either or both of Y and Z. In any case, if less than Y % of the frequencies of the STFTs for the OFR, CM pair are within Z Hz of OFR, such that all three criteria of step 300 of the process 122 are met, the OFR, CM pair is identified as potentially having two ions with oscillation frequencies within F_{W}, e.g., around 1-10 Hz, and is retained in the charged particle recovery file REC2. All of the OFR, CM pairs in the charged particle recovery file REC2 are processed in like manner, and all OFR, CM Pairs retained in REC 2 are then presumed to represent two ions with oscillation frequencies that are indiscernible from one another as described above, and are processed further at steps 302-316 of the process 122 as described below.

The process 122 advances from step 300 to step 302 where the processor 50, 52, and/or 56 is operable to select one of the OFR, CM pairs retained in the charged particle recovery file REC2 at step 300. Thereafter at step 304, the processor 50, 52 and/or 56 is operable to determine the center frequency for the two ions of the selected OFR, CM pair from the mode of the STFT frequency values for selected OFR, CM pair. Thereafter at step 306, the processor 50, 52, and/or 56 is operable to fit a sine function to the STFT charge magnitude values of the selected OFR, CM pair in order to determine the beat pattern frequency; i.e., to determine the frequency difference between the two ions. The following quantities are illustratively required for the fit performed at step 306: the charge magnitudes and frequencies for both of the ions, the phase difference, and the duration of the trapping event (as at times ions may not survive the entire trapping event). For small frequency differences the charge magnitude STFTs do not include a full beat pattern. The two ions are assumed to have charges that are not drastically different from one another, and the STFT charge magnitude data is illustratively normalized before fitting the sine function by optimizing the phase and frequency difference to minimize the root mean square deviation. A frequency difference between the two ions down to 1 Hz can be reliably determined using this approach.

Following step 306, the processor 50, 52, and/or 56 is operable at step 308 to halve the frequency difference determined at step 30, and to add this halved value to, and subtract this halved value from, the center frequency (determined at step 304) to determine the respective oscillating frequencies, OFR1 and OFR2, of each of the two ions. The two ions have the same charge magnitude, CM, which was determined using the process 100 as described above. At step 310, the processor 50, 52, and/or 56 is operable to assign this charge magnitude, CM, to each of the two ions to form two oscillating frequency and charge magnitude pairs, OFR1, CM and OFR2, CM, and to then replace the original OFR, CM pair (selected at step 302) in the charged particle recovery file REC2 with OFR1, CM and OFR2, CM. Thereafter at step 312, the processor 50, 52, and/or 56 is operable to determine whether all of the OFR, CM pairs retained in the charged particle recovery file REC2 at step 300 have been analyzed. If not the process 300 loops back to step 302 to select another OFR, CM pair, and otherwise the process 300 advances from step 312 along the YES branch.

Following step 312, the charge measurements for each set of two ions with newly assigned oscillating frequencies are still poor, having been unchanged by the steps 302-312 of the process 122. However, with the oscillation frequencies of each of the ions now in the charged particle recovery file REC2 now newly assigned, this supplies sufficient information for post analysis of such ions using the charged particle recovery process 120 of FIG. 7 to properly assign charge magnitudes to each OFR, CM pair in REC2. In some embodiments, the process 122 thus includes step 314 following the “YES” branch of step 312 in which the processor 50, 52, and/or 56 is operable to re-execute the process 120 of FIG. 7 to properly assign charge magnitudes to each OFR, CM pair in the charged particle recovery file REC2. In the re-execution of the process 120 at step 314, it will be understood that step 200 of the process 120 of FIG. 7 will be modified to operate on each OFR_{R}, CM_{R} pair in REC2 (rather than REC1 as depicted at step 200 of FIG. 7), and that the OFR_{R}, CM_{R} pairs updated by the process 120 will be added to the filtered file at step 214 of the process 120 as described above.

By executing the ion recovery process 1 alone, in embodiments of the process 100 which include step 120, charged particles with overlapping oscillation frequencies that differ by, e.g., 10-50 Hz, which would otherwise be rejected from the filtered file FF due to high charge magnitude standard deviations, are now recovered and added to the filtered file FF. By executing the ion recovery process 2 alone, in embodiments of the process 100 which include step 122, charged particles with overlapping oscillation frequencies that differ by, e.g., 1-10 Hz, which would also otherwise be rejected from the filtered file FF due to high charge magnitude standard deviations, are now recovered and added to the filtered file FF. By executing both of the ion recovery processes 1 and 2, in embodiments of the process 100 which include both of the steps 120 and 122, charged particles with overlapping oscillation frequencies that differ by, e.g., 1-50 Hz, which would otherwise be rejected from the filtered file FF due to high charge magnitude standard deviations, are now recovered and added to the filtered file FF. Thus, executing either of both of the ion recovery processes 1 and 2, spectral distribution accuracy is improved.

### EXAMPLES

### Example 1

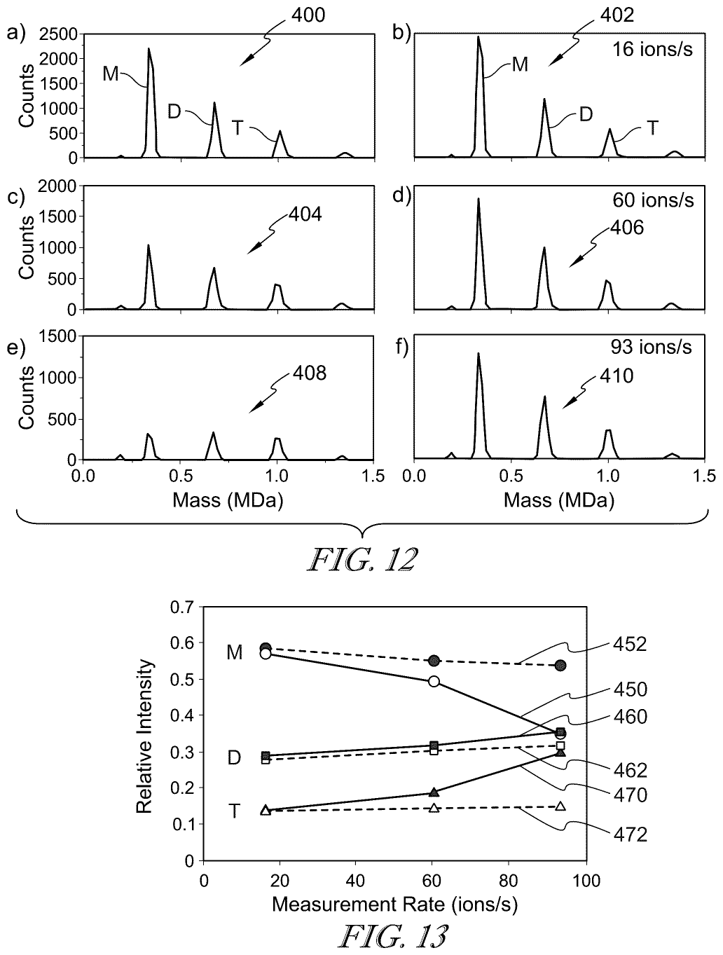

A goal of the charged particle recovery process 158 illustrated by example in FIG. 7 is to recover previously rejected and discarded charged particles by assigning proper charge values to charged particles with overlapping oscillation frequencies in cases where the oscillation frequencies of the frequency-overlapping charged particles are discernible from one another. As a result, relative abundances can be more accurately quantified regardless of signal intensity. L-glutamate dehydrogenase (GDH) was chosen as the first test case because it can be prepared at high concentration where high order oligomers can be resolved and detected by CD-MS. Representative results are shown in FIG. 12. The spectra 400, 404, 408 in FIGS. 12a), 12c) and 12e) respectively represent spectra without processing by the process 158 of FIGS. 6 and 7, i.e., they represent spectra from data in the filtered file FF after execution of step 156 of FIG. 6, and the spectra 402, 406, 410 in FIGS. 12b), 12d), and 12f) respectively represent spectra with processing by the charged particle recovery process 158. Spectra are shown for average measurement rates of 16, 60, and 93 ions/s (top to bottom in FIG. 12). The measurement rates are defined as the total number of ions in the spectrum after processing by the charged particle recovery process 158 divided by the measurement time. At 16 ions/s (the two panels 12a) and 12b)) there are peaks at M, D and T at 335 kDa, 670 kDa, and 1005 kDa respectively which are attributed to the GDH hexamer (GDH₆), the dodecamer (GDH₆) 2, and 18-mer (GDH₆)₃, respectively. (GDH₆) is the dominant species in the spectrum with a monotonic decrease in the intensity of GDH₆ oligomers. With the concentration used here, the relative abundances are around 4:2:1 for the hexamer GDH₆, (GDH₆)₂, and (GDH₆)₃, respectively. For an average measurement rate of 16 ions/s the implementation of the charged particle recovery process 158 leads to an 8% increase in the number of ions and makes a small difference to the relative abundances.

With an average measurement rate of 60 ions/s (panels 12c) and 12d)) the relative abundances in the uncorrected spectrum (panel 12c)) are clearly affected with the relative abundance of GDH₆ diminished relative to (GDH₆)₂. This illustrates a problem of trapping many ions simultaneously; the most abundant species is the most susceptible to frequency overlap and undercounting. Following application of the charged particle recovery process 158, the corrected spectrum (panel 12d)) has 45% more ions than the uncorrected and the oligomer ratio has been recovered to around 4:2:1.

With a measurement rate of 93 ions/sec, the uncorrected spectrum (panel 12e)) shows relative intensities strongly influenced by the effects of frequency overlap. The relative intensities of the monomer, dimer, and trimer peaks are similar. Following application of the charged particle recovery process 158, the number of ions in the spectrum (panel 12f)) increases by 113% and the relative intensities are similar to those in the spectrum measured at 16 ions/s.

FIG. 13 shows a plot of the relative intensities of the monomer, dimer, and trimer against measurement rate for the data set in FIG. 12. The monomer, dimer, and trimer 450, 460, 470 respectively of the uncorrected file (i.e., the original filtered file after execution of step 156), are compared to the monomer, dimer, and trimer 452, 462, 472 respectively of the corrected file (i.e., following execution of the charged particle recovery process 158). These results show that after application of the charged particle recovery process 158 the relative intensity of the monomer 452 still decreases slightly as the measurement rate is increased, and the relative intensities of the dimer 462 and trimer 472 increase slightly. However, the changes are much smaller than observed before application of the charged particle recovery process 158.

For a typical spectrum we usually collect 5,000 ions. For a CD-MS measurement where only single ions are trapped this would take around 25 minutes. At a measurement rate of 92 ions/s a 5,000-ion spectrum can be collected in under 1 minute. This is the fastest ion trap CD-MS measurement rate reported to date.

### Example 2

QB virus-like particles (VLPs) have emerged as versatile platforms for vaccine development and drug delivery. Qβ is a single stranded RNA bacteriophage that contains major and minor coat proteins (CPs), and a single maturation protein bound to the 4217 nt genomic RNA (gRNA). Assembly of the CPs around the gRNA is mediated by packaging signals to form a pseudo icosahedral T=3 capsid. Like many viruses, the CPs can also assemble into VLPs. When CPs are overexpressed alternative morphologies are often observed, and this is true for QB where in addition to the canonical icosahedral T=3 capsid with 180 CPs, oblate and prolate geometries have been observed in cryo-EM studies. The oblate form (150 CPs) is generated by removing 5 hexamers from the T=3 geometry and the prolate (210 CPs) by adding 5 hexamers. A small prolate form (132 CPs) was also observed, and a T=1 particle (60 CPs) was observed in a different study.

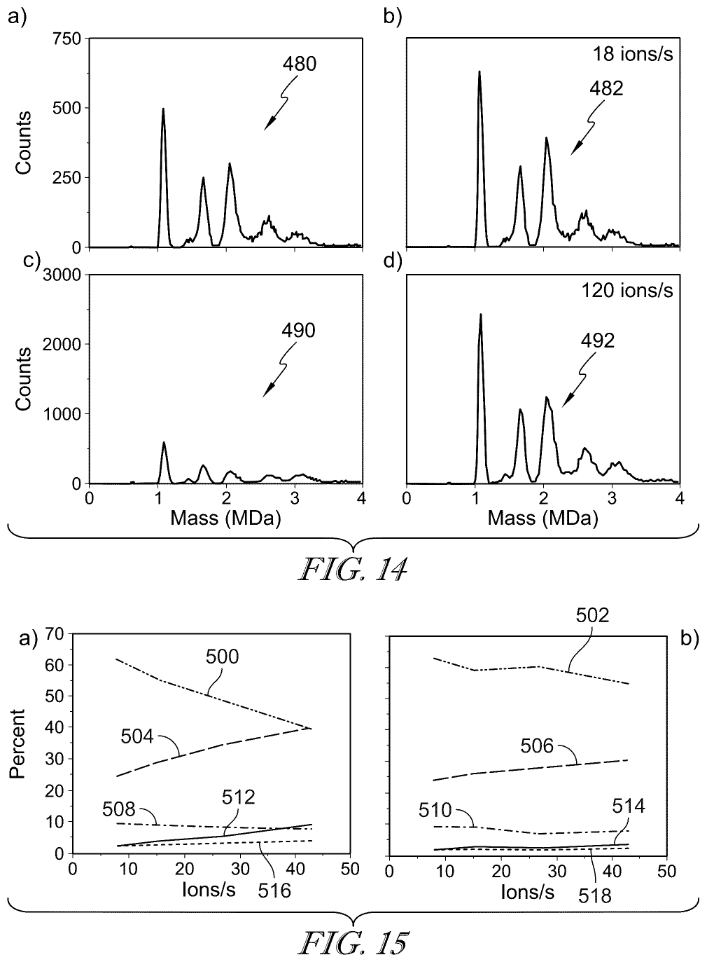

Using VLP was chosen to demonstrate the utility of the charged particle recovery process 158 for the assembly intermediates of a VLP. Uncorrected spectra 480 and 490, i.e., without the charged particle recovery process 158, are depicted in FIGS. 14a) and 14c) respectively, and corrected spectra 482 and 492 respectively, i.e., using the charged particle recovery process 158, are depicted in FIGS. 14b) and 14d). The Qβ VLP has a distribution of species from 1-3 MDa with a range of heterogeneities measured previously. FIG. 14a) shows the low ion flux measurement of Qβ VLP. Qβ is separated into five main ranges: 0-1.37, 1.37-1.87, 1.87-2.33 and 2.33-2.83 and 2.83+. These values are depicted in the table below. Due to the increased size and heterogeneity of the QB VLP even the low ion flux can be reliably measured at 18 ions per second, still much higher than attainable with single ion trapping. As depicted in the table primarily the ranges for 1.87-2.33 and 2.83-10.0 are impacted by an increase in ion flux, jumping from roughly 28% to 15% and 11% to 25%, respectively. After charged particle recovery correction these fluctuations are heavily mitigated dropping from 30% only to 26% for the 1.87-2.33 range and 10% to 14% for the 2.83-10.0 range.

| | 18 | 120 | 18 | 120 |
|---|---|---|---|---|
| Ranges | Pre-MICE | Pre-MICE | Post-MICE | Post-MICE |
| 0.00-1.37 | 25.28 | 26.71 | 25.58 | 26.25 |
| 1.37-1.87 | 20.51 | 18.53 | 19.54 | 18.13 |
| 1.87-2.33 | 28.39 | 15.32 | 30.27 | 26.60 |
| 2.33-2.83 | 14.81 | 14.02 | 14.5 | 14.65 |
| 2.83-10.0 | 11.01 | 25.42 | 10.12 | 14.37 |

In this case the charged particle recovery process 158 once again shows little change to the other ranges and the relative abundance of the spectrum but yields 367% more ions in the final output showcasing how fast the measurements can be made.

As expected for the high flux measurement the most prominent and homogenous species decreases in intensity, and it is only after the charged particle recovery process is applied does the sample trace return to the abundances of the low flux sample. Also, of note the total number of ions substantially increases resulting in an ion flux of 120 ions per second shown in FIG. 14d). If this megadalton sized species was to be separated by liquid chromatography we would expect a similar ion flux and according to these results this signal intensity could be assessed in real time by multiple ion CD-MS.

### Example 3

Recombinant adeno-associated virus (AAV) is a gene therapy vector with three FDA approved treatments. CD-MS has shown great utility as a tool for characterizing AAV preparations. The relative abundances of empty AAV particles, particles that have packaged a partial genome, and particles that have packaged the full genome (the empty/partial/full ratio) is a critical quality attribute. Thus, the application of the charged particle recovery process 158 to the high throughput analysis of AAV is particularly pertinent.

Spectra were measured at four different rates (8, 15, 27 and 43 ions/s) the number of ions were integrated over five mass bands: empty 3.4 to 3.8 MDa (empty), 3.8-4.16 MDa (partial), 4.16-4.55 MDa (full), 4.55-4.85 MDa (intermediate), and 4.85-5.6 MDa (overpackaged). FIG. 15a) shows the relative abundances for the five bands plotted as a function of measurement rate prior to processing by the charged particle recovery process 158; the mass bands 500, 504, 508, 512 and 516 identified in FIG. 15a) correspond to mass bands 4.16-4.55, 4.85-5.6, 4.55-4.85, 3.4-3.8, and 3.8-4.16 MDa, respectively. There is a substantial systematic decrease in the relative abundance of the most abundant species (the full peak at 4.3 MDa). The relative abundances for the empty and overpackaged peaks increase with the measurement rate. However, the relative abundances for the partial and intermediate bands (between the three peaks) show less variability. FIG. 15b) shows relative abundances after processing with the charged particle recovery process 158 plotted against measurement rate. In FIG. 15b), the mass bands 502, 506, 510, 514 and 518 correspond to mass bands 4.16-4.55, 4.85-5.6, 4.55-4.85, 3.4-3.8, and 3.8-4.16 MDa, respectively. The variations in the relative abundances are much less pronounced than in the unprocessed data of FIG. 15a).

### Example 4

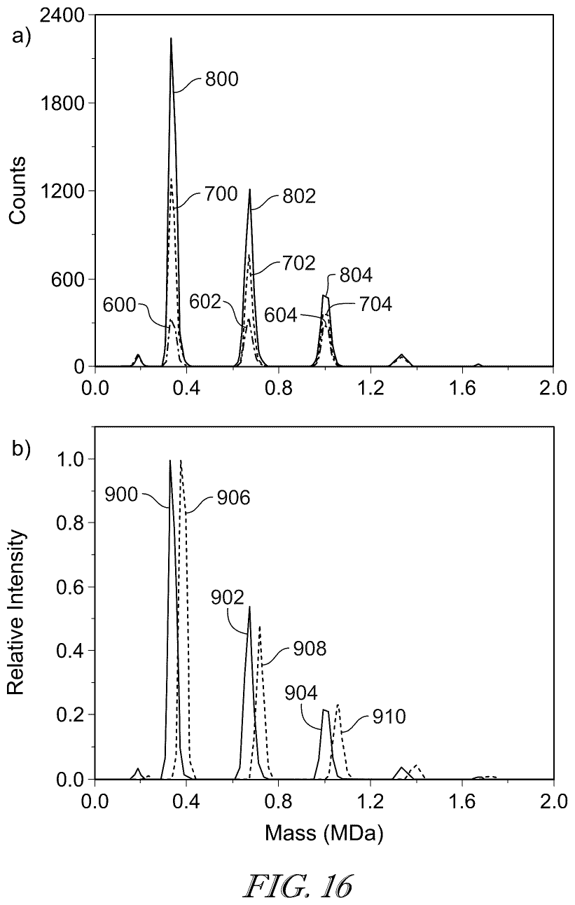

To evaluate the performance of the charged particle recovery process 300 illustrated in FIG. 11, the L-glutamate dehydrogenase (GDH) analyzed in Example 1 using the charged particle recovery process 158 illustrated in FIG. 7 was reanalyzed using the process 300. FIG. 16a) shows a comparison of CDMS data analyzed without the charged particle recovery process 158 or the charged particle recovery process 300 (peaks 600, 602, and 604), with the charged particle recovery process 158 illustrated in FIG. 7 (peaks 700, 702, and 704), and with the charged particle recovery process 300 illustrated in FIG. 11 (peaks 800, 802, and 804). The charged particle recovery process 300 increases the total number of ions in the spectrum by 64% which, in some embodiments, increases the measurement rate from approximately 90 ions/sec to almost 150 ions/s. This means that, in some embodiments, the time required to measure a typical spectrum of 5,000 ions is reduced from 56 s to 34 s.

The original spectrum 600, 602, 604 illustrates the discrimination that occurs at high count rates. It should be noted that the most abundant species in the original spectrum are the most diminished relative to the spectrum 800, 802, 804 corresponding to the process 300, so that in the original spectrum the three mass peaks 600, 602, 604 have roughly the same abundance. Application of the charged particle recovery process 158 substantially increases the abundances of the two lowest mass peaks 700, 702, and application of the charged particle recovery process 300 further increases the relative abundances of the lowest mass peaks 800, 802. To verify that the charged particle recovery process 300 recovers the relative abundance ratios that would be measured with a low count rate, FIG. 16b) shows a comparison of the spectrum measured at 150 ions/s (peaks 900, 902, 904) with a spectrum measured for the same sample at a much lower count rate, 16 ions/s (peaks 906, 908, 910). The spectrum measured at 16 ions/s is offset in FIG. 16b) to facilitate comparison. The relative abundances are very similar.

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of this disclosure are desired to be protected. For example, it will be understood that the ELIT 14 illustrated in the attached figures and described herein is provided only by way of example, and that the concepts, structures, and techniques described above may be implemented directly in ELITs of various alternate designs. Any such alternate ELIT design may, for example, include any one or combination of two or more ELIT regions, more, fewer and/or differently-shaped ion mirror electrodes, more or fewer voltage sources, more or fewer voltage signals produced by one or more of the voltage sources, one or more ion mirrors defining additional electric field regions, or the like.

What is claimed is:

1. A method of operating a charge detection mass spectrometer including an electrostatic linear ion trap (ELIT) or an orbitrap, the method comprising:
(i) trapping multiple ions, generated from a sample, in the ELIT or orbitrap such that the multiple trapped ions oscillate back and forth through or about a charge detector of the ELIT or orbitrap during an ion trapping event,
(ii) determining a set of oscillation frequency (OFR) and charge magnitude (CM) pairs each corresponding to a different one of the multiple trapped ions,
(iii) forming filtered and recovery files from the set of OFR and CM pairs, the filtered file including OFR and CM pairs from which a spectral distribution of the sample is to be produced, and the recovery file including OFR and CM pairs having oscillation frequencies that overlap with oscillation frequencies of other OFR and CM pairs, wherein the overlapping oscillation frequencies in the recovery file are discernible from one another,
(iv) for at least one of the OFR and CM pairs in the recovery file, (a) modifying the charge magnitude of the OFR and CM pair as a function of the charge magnitude of one of the OFR and CM pairs in the filtered file having an oscillation frequency in the ELIT or orbitrap that is within a frequency window of an oscillation frequency in the ELIT or orbitrap of the OFR and CM pair, and (b) updating the filtered file by adding the OFR and modified CM pair thereto, and
(v) producing the spectral distribution from the updated filtered file of OFR and CM pairs.

2. The method of claim 1, further comprising executing (i)-(iv) multiple times, followed by executing (v) using the updated filtered file containing OFR and CM pairs for all of the multiple executions of (i)-(iv).

3. The method of claim 1, further comprising collecting charge detection data resulting from detection of charges induced by the multiple ions on the charge detector over the ion trapping event,
wherein (ii) comprises analyzing the collected charge data to determine the set of oscillation frequency (OFR) and charge magnitude (CM) pairs, and to determine a charge magnitude standard deviation for each of the OFR and CM pairs.

4. The method of claim 3, wherein (iv) further comprises requiring the OFR and CM pairs in the filtered file to have charge magnitude standard deviations less than a first threshold, and requiring the OFR and CM pairs in the recovery file to have charge magnitude standard deviations greater than the first threshold.

5. The method of claim 1, further comprising executing (iv) for each of the OFR and CM pairs in the recovery file.

6. The method of claim 1, wherein (iv) comprises:
collecting charge magnitudes for all OFR and CM pairs in the filtered file that have an oscillation frequency in the ELIT or orbitrap within the frequency window of the oscillation frequency in the ELIT or orbitrap of the OFR and CM pair in the recovery file,
randomly selecting one of the collected charge magnitudes, and
modifying the charge magnitude of the OFR and CM pair in the recovery file as a function of the randomly selected charge magnitude.

7. The method of claim 6, wherein modifying the charge magnitude comprises:
modifying the charge magnitude of the randomly selected one of the collected charge magnitudes by adding a noise value thereto, and
replacing the charge magnitude of the OFR and CM pair in the recovery file with the modified charge magnitude.

8. The method of claim 1, further comprising, between (i) and (ii):
collecting charge detection data resulting from detection of charges induced by the multiple ions on the charge detector over the ion trapping event, and
computing a series of short-time overlapping Fourier transforms (STFTs) stepped sequentially through the collected charge detection data, the STFTs including STFT frequency values and STFT charge values,
and wherein (ii) comprises determining the set of OFR and CM pairs, from the STFT frequency values and the STFT charge values.

9. The method of claim 8, wherein the recovery file comprises a first recovery file,
and wherein (iii) further comprises forming a second recovery file from the set of OFR and CM pairs, the second recovery file including OFR and CM pairs having oscillation frequencies that overlap with oscillation frequencies of other OFR and CM pairs, wherein the overlapping oscillation frequencies in the second recovery file are indiscernible from one another,
and wherein the method further comprises the following between (iv) and (v):
(vi) for at least one of the OFR and CM pairs in the second recovery file, (a) determining first and second OFR values as a function of the STFT charge and frequency values for the OFR and CM pair, and (b) modifying the second recovery file by replacing the OFR and CM pair in the second recovery file with first and second OFR and CM pairs, the first OFR and CM pair having the determined first OFR value and the charge magnitude of the OFR and CM pair, and the second OFR and CM pair having the determined second OFR value and the charge magnitude of the OFR and CM pair.

10. The method of claim 9, further comprising executing (vi) for each of the OFR and CM pairs in the second recovery file.

11. The method of claim 9, further comprising the following after (vi) and between (iv) and (v):
(viii) for each OFR and CM pair in the modified second recovery file (a) modifying the charge magnitude of the OFR and CM pair as a function of the charge magnitude of one of the OFR and CM pairs in the filtered file having an oscillation frequency in the ELIT or orbitrap that is within a frequency window of an oscillation frequency in the ELIT or orbitrap of the OFR and CM pair, and (b) updating the filtered file by adding the OFR and CM pair, with the modified charge magnitude, to the filtered file.

12. The method of claim 9, wherein (vi) comprises determining the first and second OFR values as a function of the STFT charge and frequency values for the selected OFR and CM pair by:
(1) determining a center frequency from a mode of the STFT frequency values for the selected OFR and CM pair,
(2) fitting a sine function to the STFT charge values for the selected OFR and CM pair to determine a frequency difference,
(3) adding one half of the frequency difference to the center frequency to determine the first OFR value, and
(4) subtracting one half of the frequency difference from the center frequency to determine the second OFR value.

13. The method of claim 9, wherein forming the second recovery file further comprises processing the STFTs and including in the second recovery file only OFR and CM pairs for which:
a variation in respective STFT charge values across the STFTs exceeds a first percentage,
the variation in the respective STFT charge values across the STFTs is non-linear in shape, and
less than a second percentage of the respective STFT frequencies across the STFTs are within a frequency threshold of the oscillating frequency of the respective OFR and CM pair.

14. The method of claim 11, further comprising executing (i)-(iv), (vi), and (vii) multiple times, followed by executing (v) using the updated filtered file containing OFR and CM pairs for all of the multiple executions of (i)-(iv), (vi) and (vii).

15. The method of claim 1, wherein (v) comprises determining for each OFR and CM pair in the updated filtered file at least one of a mass-to-charge ratio and a mass of the respective ion, and including in the spectral distribution for each OFR and CM pair in the updated filtered file one or any combination of the respective mass, mass-to-charge ratio, and charge magnitude (CM).

16. A method of operating a charge detection mass spectrometer including an electrostatic linear ion trap (ELIT) or an orbitrap, the method comprising:
(i) trapping multiple ions, generated from a sample, in the ELIT or orbitrap such that the multiple trapped ions oscillate back and forth through or about a charge detector of the ELIT or orbitrap during an ion trapping event,
(ii) collecting charge detection data resulting from detection of charges induced by the multiple ions on the charge detector over the ion trapping event,
(iii) determining from the collected charge detection data a set of oscillation frequency (OFR) and charge magnitude (CM) pairs each corresponding to a different one of the multiple trapped ions,
(iv) forming a filtered file and first and second recovery files from the set of OFR and CM pairs, the filtered file including OFR and CM pairs from which a spectral distribution of the sample is to be produced, the first and second recovery files each including OFR and CM pairs having oscillation frequencies that overlap with oscillation frequencies of other OFR and CM pairs, wherein the overlapping oscillation frequencies in the first recovery file are discernible from one another, and the overlapping oscillation frequencies in the second recovery file are indiscernible from one another,
(v) for at least one of the OFR and CM pairs in the first recovery file, (a) modifying the charge magnitude of the OFR and CM pair as a function of the charge magnitude of one of the OFR and CM pairs in the filtered file having an oscillation frequency in the ELIT or orbitrap that is within a frequency window of an oscillation frequency in the ELIT or orbitrap of the OFR and CM pair, and (b) updating the filtered file by adding the OFR and modified CM pair thereto,
(vi) for at least one of the OFR and CM pairs in the second recovery file, (a) determining from the collected charge detection data first and second OFR values for the OFR and CM pair, and (b) modifying the second recovery file by replacing the OFR and CM pair in the second recovery file with first and second OFR and CM pairs, the first OFR and CM pair having the determined first OFR value and the charge magnitude of the OFR and CM pair, and the second OFR and CM pair having the determined second OFR value and the charge magnitude of the OFR and CM pair,
(vii) for each OFR and CM pair in the modified second recovery file (a) modifying the charge magnitude of the OFR and CM pair as a function of the charge magnitude of one of the OFR and CM pairs in the filtered file having an oscillation frequency in the ELIT or orbitrap that is within a frequency window of an oscillation frequency in the ELIT or orbitrap of the OFR and CM pair, and (b) updating the filtered file by adding the OFR and CM pair, with the modified charge magnitude, to the filtered file, and
(viii) producing a spectral distribution of the sample from the updated filtered file.

17. The method of claim 16, further comprising executing (i)-(vii) multiple times, followed by executing (viii) using the updated filtered file containing OFR and CM pairs for all of the multiple executions of (i)-(vii).

18. The method of claim 16, wherein (iii) comprises:
computing a series of short-time overlapping Fourier transforms (STFTs) stepped sequentially through the collected charge detection data, the STFTs including STFT charge values and STFT frequency values, and
determining the set of OFR and CM pairs from the STFT charge and frequency values.

19. The method of claim 18, wherein (vi)(a) comprises determining the first and second OFR values as a function of the STFT charge and frequency values for the selected OFR and CM pair by:
(1) determining a center frequency from a mode of the STFT frequency values for the selected OFR and CM pair,
(2) fitting a sine function to the STFT charge values for the selected OFR and CM pair to determine a frequency difference,
(3) adding one half of the frequency difference to the center frequency to determine the first OFR value, and
(4) subtracting one half of the frequency difference from the center frequency to determine the second OFR value.

20. The method of claim 18, wherein forming the second recovery file further comprises processing the STFTs and including in the second recovery file only OFR and CM pairs for which:
a variation in respective STFT charge values across the STFTs exceeds a first percentage,
the variation in the respective STFT charge values across the STFTs is non-linear in shape, and
less than a second percentage of the respective STFT frequencies across the STFTs are within a frequency threshold of the oscillating frequency of the respective OFR and CM pair.
